(19) United States
(12) Patent Application Publication
(10) Pub. No.: US 2025/0286408 A1
(43) Pub. Date: Sep. 11, 2025

(54) HALF-BRIDGE STARTUP CIRCUIT, WIRELESS CHARGING RECEIVER, AND CHIP

(71) Applicant: Zhuhai Nanxin Semiconductor Technology Co., Ltd., Zhuhai City (CN)

(72) Inventor: Lixu Gao, Zhuhai City (CN)

(21) Appl. No.: 19/075,072

(22) Filed: Mar. 10, 2025

(30) Foreign Application Priority Data
Mar. 11, 2024 (CN) 202410271835.4

(51) Int. Cl. H02J 50/12; H02J 7/34; H02M 1/36; H02M 7/219

(52) U.S. Cl. CPC H02J 50/12; H02J 7/345; H02M 1/36; H02M 7/219; H02J 2207/50

(57) ABSTRACT

The present disclosure provides a half-bridge startup circuit, a wireless charging receiver, a chip, and a device. The half-bridge startup circuit includes a first energy storage circuit and a second energy storage circuit. Within a first half cycle of an alternating current signal, the first energy storage circuit is charged based on a voltage at an output terminal and a voltage at a target midpoint, such that a first voltage difference between a second terminal and a third terminal of the first energy storage circuit increases. Within a second half cycle of the alternating current signal, the first energy storage circuit discharges to the second energy storage circuit, such that a second voltage difference between a second terminal and a third terminal of the second energy storage circuit increases. In this way, an output voltage desired by half-bridge startup is reduced.

### CROSS-REFERENCE TO RELATED APPLICATION

This application is based upon and claims the priority of Chinese Patent Application No. 202410271835.4, filed on Mar. 11, 2024, the entire contents of which are hereby incorporated by reference.

### TECHNICAL FIELD

The present disclosure relates to the technical field of wireless charging, and in particular, relates to a half-bridge startup circuit, a wireless charging receiver, a chip, and a device.

### BACKGROUND

With the development of science and technology, electronic devices may be charged using a wireless charging system. The wireless charging system includes a wireless charging transmitter circuit and a wireless charging receiver circuit. The wireless charging receiver circuit is arranged in the electronic device. The wireless charging receiver circuit includes a rectifier circuit and a resonant circuit. The rectifier circuit is configured to converting an alternating current signal output by the resonant circuit to a direct current signal for output, such that the electronic device is charged.

The rectifier circuit in the wireless charging receiver circuit may operate in a half bridge mode or a full bridge mode. In a case that the rectifier circuit operates in the half bridge mode, an output voltage is higher than that in the full bridge mode. The output voltage of the wireless charging receiver circuit is increased, such that a power module in the electronic device electrically connected to the wireless charging receiver circuit starts, and hence the electronic device is charged.

In the related art, switching from the full bridge mode to the half bridge mode is achieved by arranging a half-bridge startup circuit and a rectifier circuit in the wireless charging receiver circuit. The half-bridge startup circuit controls, based on the output voltage of the wireless charging receiver circuit, the rectifier circuit in the wireless charging receiver circuit to operate in the half bridge mode, such that the charging requirement of the electronic device is satisfied and low-voltage startup is achieved. However, in some special scenarios, the wireless charging system has a low conversion efficiency. As a result, the wireless charging receiver circuit has a low output voltage, the system fails to normally operate, and thus the rectifier circuit fails to switch from the full bridge mode to the half bridge mode.

Therefore, it is an urgent problem to cause the rectifier circuit to operate in the half bridge mode to achieve half-bridge startup in a case that the output voltage of the wireless charging receiver circuit is low.

### SUMMARY

The present disclosure provides a half-bridge startup circuit, a wireless charging receiver, a chip, and a device, such that half-bridge startup is implemented in a case that a voltage at an output terminal of a wireless charging receiver circuit is low.

In a first aspect, the present disclosure provides a half-bridge startup circuit, electrically connected to a wireless charging receiver circuit, and the wireless charging receiver circuit includes a rectifier circuit and a resonant circuit; wherein the rectifier circuit includes a first switch transistor, a second switch transistor, a third switch transistor, a fourth switch transistor, and a first capacitor; wherein a second terminal of the first switch transistor is electrically connected to a first terminal of the second switch transistor, a second terminal of the third switch transistor is electrically connected to a first terminal of the fourth switch transistor, a first terminal of the first switch transistor and a first terminal of the third switch transistor are both electrically connected to an output terminal of the wireless charging receiver circuit, and a second terminal of the second switch transistor and a second terminal of the fourth switch transistor are both grounded; the first terminal of the third switch transistor is further grounded via the first capacitor; wherein a point between the first switch transistor and the second switch transistor is defined as a first midpoint, and a point between the third switch transistor and the fourth switch transistor is defined as a second midpoint; the resonant circuit is configured to convert a signal transmitted from a wireless charging transmitter to an alternating current signal, and output the alternating current signal, via the first midpoint and the second midpoint, to the rectifier circuit; and the rectifier circuit is configured to convert the alternating current signal to a direct current charging signal for output; and the half-bridge startup circuit includes a first energy storage circuit and a second energy storage circuit; wherein a first terminal of the first energy storage circuit is electrically connected to the output terminal of the wireless charging receiver circuit, a second terminal of the first energy storage circuit is electrically connected to a target midpoint, a third terminal of the first energy storage circuit is electrically connected to a first terminal of the second energy storage circuit, a second terminal of the second energy storage circuit is electrically connected to a control terminal of a target switch transistor, and a third terminal of the second energy storage circuit is grounded; wherein the target midpoint is the second midpoint in a case that the target switch transistor is the second switch transistor, or the target midpoint is the first midpoint in a case that the target switch transistor is the fourth switch transistor; within a first half cycle of the alternating current signal, the first energy storage circuit is charged based on a voltage at the output terminal and a voltage at the target midpoint, such that a first voltage difference between the second terminal and the third terminal of the first energy storage circuit increases; within a second half cycle of the alternating current signal, the first energy storage circuit is discharged to transmit electric energy to the second energy storage circuit, such that a second voltage difference between the second terminal and the third terminal of the second energy storage circuit increases; and in a case that the second voltage difference is greater than a threshold voltage of the target switch transistor, the target switch transistor is turned on, another switch transistor on the same bridge arm as the target switch transistor is turned off, and two switch transistors on a bridge arm not including the target switch transistor in the rectifier circuit are alternately turned on to convert the alternating current signal output by the resonant circuit to the direct current charging signal; wherein in a case that the target switch transistor is turned on, the second voltage difference is greater than the voltage at the output terminal; wherein the first switch transistor and the second switch transistor are arranged on a bridge arm, and the third switch transistor and the fourth switch transistor are arranged on another bridge arm.

In some embodiments, the first energy storage circuit includes a first unidirectional conducting branch and a first energy storage branch; wherein the first energy storage branch includes one fifth capacitor or a plurality of fifth capacitors that are connected in series; and an ON direction of the first unidirectional conducting branch is from a first terminal of the first unidirectional conducting branch to a second terminal of the first unidirectional conducting branch; wherein the first terminal of the first unidirectional conducting branch, as the first terminal of the first energy storage circuit, is electrically connected to the output terminal of the wireless charging receiver circuit; in a case that the first energy storage branch includes one fifth capacitor, the second terminal of the first unidirectional conducting branch, as the third terminal of the first energy storage circuit, is electrically connected to a first terminal of the fifth capacitor, and a second terminal of the fifth capacitor is electrically connected to the target midpoint; or in a case that the first energy storage branch includes a plurality of fifth capacitors that are connected in series, the second terminal of the first unidirectional conducting branch is electrically connected to a first terminal of a 1^{st} fifth capacitor in the plurality of fifth capacitors that are connected in series, a second terminal of a last fifth capacitor in the plurality of fifth capacitors that are connected in series is electrically connected to the target midpoint, and a second terminal of an i^{th} fifth capacitor in the plurality of fifth capacitors that are connected in series is electrically connected to a first terminal of an (i+1)^{th} fifth capacitor in the plurality of fifth capacitors that are connected in series, wherein i is greater than 0 and is less than a number of the fifth capacitors; and within the first half cycle of the alternating current signal, the first unidirectional conducting branch is in an ON state, the fifth capacitor or the plurality of fifth capacitors that are connected in series on the first energy storage branch are charged based on the voltage at the output terminal of the wireless charging receiver circuit and the voltage at the target midpoint, such that a voltage difference between two terminals of the first energy storage branch increases.

In some embodiments, the first unidirectional conducting branch includes a first unidirectional conducting device, and the first unidirectional conducting device is a first diode, an N-type metal-oxide-semiconductor (NMOS) transistor, or a P-type metal-oxide-semiconductor (PMOS) transistor; wherein in a case that the first unidirectional conducting device is the first diode, a positive electrode of the first diode, as the first terminal of the first unidirectional conducting branch, is electrically connected to the output terminal of the wireless charging receiver circuit, and a negative electrode of the first diode, as the second terminal of the first unidirectional conducting branch, is electrically connected to the first terminal of the fifth capacitor or is electrically connected to the first terminal of a 1^{st} fifth capacitor in the plurality of fifth capacitors that are connected in series; in a case that the first unidirectional conducting device is the NMOS transistor, a substrate of the NMOS transistor is electrically connected to a gate electrode of the NMOS transistor, the gate electrode of the NMOS transistor is electrically connected to a source electrode of the NMOS transistor, the source electrode of the NMOS transistor, as the first terminal of the first unidirectional conducting branch, is electrically connected to the output terminal of the wireless charging receiver circuit, and a drain electrode of the NMOS transistor, as the second terminal of the first unidirectional conducting branch, is electrically connected to the first terminal of the fifth capacitor or is electrically connected to the first terminal of the 1^{st} fifth capacitor in the plurality of fifth capacitors that are connected in series; or in a case that the first unidirectional conducting device is the PMOS transistor, a substrate of the PMOS transistor is electrically connected to a gate electrode of the PMOS transistor, the gate electrode of the PMOS transistor is electrically connected to a source electrode of the PMOS transistor, a drain electrode of the PMOS transistor, as the first terminal of the first unidirectional conducting branch, is electrically connected to the output terminal of the wireless charging receiver circuit, and a source electrode of the PMOS transistor, as the second terminal of the first unidirectional conducting branch, is electrically connected to the first terminal of the fifth capacitor or is electrically connected to the first terminal of the 1^{st} fifth capacitor in the plurality of fifth capacitors that are connected in series; and the first unidirectional conducting device is turned on within the first half cycle of the alternating current signal, such that the first unidirectional conducting branch is in the ON state.

In some embodiments, the first unidirectional conducting branch further includes a second resistor, a first terminal of the second resistor is electrically connected to the output terminal of the wireless charging receiver circuit; wherein in a case that the first unidirectional conducting device is the first diode, a second terminal of the second resistor is electrically connected to the positive electrode of the first diode; in a case that the first unidirectional conducting device is the NMOS transistor, a second terminal of the second resistor is electrically connected to the source electrode of the NMOS; or in a case that the first unidirectional conducting device is the PMOS transistor, a second terminal of the second resistor is electrically connected to the drain electrode of the PMOS transistor; and the second resistor is configured to limit a current on the first unidirectional conducting branch.

In some embodiments, the second energy storage circuit includes a second unidirectional conducting branch and a second energy storage branch; wherein the second energy storage branch includes one sixth capacitor or a plurality of sixth capacitors that are connected in series; and an ON direction of the second unidirectional conducting branch is from a first terminal of the second unidirectional conducting branch to a second terminal of the second unidirectional conducting branch; wherein a first terminal of the second unidirectional conducting branch, as the first terminal of the second energy storage circuit, is electrically connected to the third terminal of the first energy storage circuit, and a second terminal of the second unidirectional conducting branch, as the second terminal of the second energy storage circuit, is electrically connected to the control terminal of the target switch transistor; in a case that the second energy storage branch includes one sixth capacitor, the second terminal of the second unidirectional conducting branch is electrically connected to a first terminal of the sixth capacitor, and a second terminal of the sixth capacitor is grounded; or in a case that the second energy storage branch includes the plurality of sixth capacitors that are connected in series, the second terminal of the second unidirectional conducting branch is electrically connected to a first terminal of a 1^{st} sixth capacitor in the plurality of sixth capacitors that are connected in series, a second terminal of a last sixth capacitor in the plurality of sixth capacitors that are connected in series is grounded, and a second terminal of a j^{th} sixth capacitor in the plurality of sixth capacitors that are connected in series is electrically connected to a first terminal of a (j+1)th sixth capacitor in the plurality of sixth capacitors that are connected in series, wherein j is greater than 0 and is less than a number of the sixth capacitors; and within the second half cycle of the alternating current signal, the second unidirectional conducting branch is in an ON state, the 1^{st} sixth capacitor or the plurality of sixth capacitors that are connected in series on the second energy storage branch are charged based on a voltage at the third terminal of the first energy storage circuit, such that a voltage difference between two terminals of the second energy storage branch increases.

In some embodiments, the second unidirectional conducting branch includes a second unidirectional conducting device, and the second unidirectional conducting device is a second diode, an NMOS transistor, or a PMOS transistor; wherein in a case that the second unidirectional conducting device is the second diode, a positive electrode of the second diode, as the first terminal of the second unidirectional conducting branch, is electrically connected to the third terminal of the first energy storage circuit, and a negative electrode of the second diode, as the second terminal of the second unidirectional conducting branch, is electrically connected to the control terminal of the target switch transistor; in a case that the second unidirectional conducting device is the NMOS transistor, a substrate of the NMOS transistor is electrically connected to a gate electrode of the NMOS transistor, the gate electrode of the NMOS transistor is electrically connected to a source electrode of the NMOS transistor, the source electrode of the NMOS transistor, as the first terminal of the second unidirectional conducting branch, is electrically connected to the third terminal of the first energy storage circuit, and a drain electrode of the NMOS transistor, as the second terminal of the second unidirectional conducting branch, is electrically connected to the control terminal of the target switch transistor; or in a case that the second unidirectional conducting device is the PMOS transistor, a substrate of the PMOS transistor is electrically connected to a gate electrode of the PMOS transistor, the gate electrode of the PMOS transistor is electrically connected to a source electrode of the PMOS transistor, a drain electrode of the PMOS transistor, as the first terminal of the second unidirectional conducting branch, is electrically connected to the third terminal of the first energy storage circuit, and a source electrode of the PMOS transistor, as the second terminal of the second unidirectional conducting branch, is electrically connected to the control terminal of the target switch transistor.

In some embodiments, the second energy storage circuit further includes a second Zener diode; wherein a negative electrode of the second Zener diode is electrically connected to the first terminal of the second unidirectional conducting branch, and a positive electrode of the second Zener diode is grounded; and the second Zener diode is turned on in a case that a voltage at the first terminal of the second unidirectional conducting branch is greater than a first threshold, and is configured to clamp the voltage at the first terminal of the second energy storage circuit to be less than or equal to the first threshold.

In some embodiments, the target switch transistor is the fourth switch transistor; wherein within the first half cycle of the alternating current signal, the second switch transistor and the third switch transistor are turned on, and the fourth switch transistor and the second switch transistor are turned off; and within the second half cycle of the alternating current signal, the second switch transistor and the third switch transistor are turned off, and the fourth switch transistor and the second switch transistor are turned on.

In some embodiments, the target switch transistor is the second switch transistor; wherein within the first half cycle of the alternating current signal, the second switch transistor and the third switch transistor are turned off, and the fourth switch transistor and the second switch transistor are turned on; and within the second half cycle of the alternating current signal, the second switch transistor and the third switch transistor are turned on, and the fourth switch transistor and the second switch transistor are turned off.

In a second aspect, the present disclosure provides a wireless charging receiver. The wireless charging receiver includes a receiver coil, a second capacitor, a rectifier circuit, and the half-bridge startup circuit according to the first aspect; wherein the rectifier circuit includes a first switch transistor, a second switch transistor, a third switch transistor, a fourth switch transistor, and a first capacitor; wherein the receiver coil is magnetically coupled to a transmitter coil in the wireless charging transmitter and electrically connected to the rectifier circuit, and is configured to receive an alternating current signal from the transmitter coil and transmit the alternating current signal to the rectifier circuit; and the rectifier circuit is configured to convert the alternating current signal to a direct current charging signal for output; and wherein a second terminal of the first switch transistor is electrically connected to a first terminal of the second switch transistor, a second terminal of the third switch transistor is electrically connected to a first terminal of the fourth switch transistor, a first terminal of the first switch transistor and a first terminal of the third switch transistor are both electrically connected to an output terminal of the rectifier circuit, and a second terminal of the second switch transistor and a second terminal of the fourth switch transistor are both grounded; the first terminal of the third switch transistor is further grounded via the first capacitor; and a first midpoint is electrically connected to a first terminal of the receiver coil, a second terminal of the receiver coil is electrically connected to a first terminal of the second capacitor, and a second terminal of the second capacitor is electrically connected to a second midpoint; wherein a point between the first switch transistor and the second switch transistor is defined as the first midpoint, and a point between the third switch transistor and the fourth switch transistor is defined as the second midpoint.

In a third aspect, the present disclosure provides a chip. The chip includes half-bridge startup circuit according to the first aspect of the present disclosure, or the wireless charging receiver according to the second aspect of the present disclosure.

In a fourth aspect, the present disclosure provides an electronic device. The electronic device includes the chip according to the third aspect of the present disclosure.

In a fifth aspect, the present disclosure provides a wireless charging system. The wireless charging system includes a wireless transmitter circuit and the wireless charging receiver according to the present disclosure.

In the half-bridge startup circuit according to the present disclosure, within the first half cycle, the first energy storage circuit is in a charging state, such that the first voltage difference between the second terminal and the third terminal of the first energy storage circuit increases; and within the second half cycle, the first energy storage circuit charges the second energy storage circuit, such that the second voltage difference between the second terminal and the third terminal of the second energy storage circuit increases. In a case that the second voltage difference is greater than a threshold voltage of the target switch transistor, the target switch transistor is turned on, such that the wireless charging receiver circuit operates in a half bridge mode. In a case that the target switch transistor is turned on, the second voltage difference is greater than the voltage at the output terminal of the wireless charging receiver circuit, that is, a half-bridge startup voltage boosts the output voltage of the wireless charging receiver circuit, such that the charging requirements of the terminal device are met in scenarios where the voltage at the output terminal is relatively low.

### BRIEF DESCRIPTION OF THE DRAWINGS

FIG. 1 is a schematic structural diagram of a wireless charging receiver circuit according to some embodiments of the present disclosure;

FIG. 2 is a schematic diagram of waveforms of voltage signals at some endpoints in the wireless charging receiver circuit in a full bridge mode according to some embodiments of the present disclosure;

FIG. 3 is a schematic structural diagram of a half-bridge startup circuit in the related art;

FIG. 4 is a schematic structural diagram of a half-bridge startup circuit in the related art;

FIG. 5 is a schematic structural diagram of a half-bridge startup circuit according to some embodiments of the present disclosure;

FIG. 6A is a schematic structural diagram of a half-bridge startup circuit according to some embodiments of the present disclosure;

FIG. 6B is a schematic diagram of a connection relationship between the wireless charging receiver circuit and the half-bridge startup circuit according to some embodiments of the present disclosure;

FIG. 7 is a schematic diagram of waveforms of voltage signals at some endpoints in the wireless charging receiver circuit in a half bridge mode according to some embodiments of the present disclosure;

FIG. 8 is a schematic structural diagram of a half-bridge startup circuit according to some embodiments of the present disclosure;

FIG. 9 is a schematic structural diagram of a half-bridge startup circuit according to some embodiments of the present disclosure;

FIG. 10 is a schematic structural diagram of a half-bridge startup circuit according to some embodiments of the present disclosure;

FIG. 11 is a schematic structural diagram of a half-bridge startup circuit according to some embodiments of the present disclosure; and

FIG. 12 is a schematic structural diagram of a wireless charging receiver according to some embodiments of the present disclosure.

### DETAILED DESCRIPTION OF THE EMBODIMENTS

In the present disclosure, the term “at least one” refers to one or more than one, and the term “a plurality of” refers to two or more than two. The term “and/or” is merely an association relationship for describing associated objects, which represents that there may exist three types of relationships, for example, A and/or B may represent three situations: only A exists, both A and B exist, and only B exists, wherein A and B may be single or plural. In addition, the symbol “/” generally represents an “or” relationship between associated objects before and after the symbol. The expression “at least one of the following” or the like expression means any combination of the items or options listed, including a single item or option or any combination of plural items or options listed. For example, at least one of a single a, a single b, and a single c may indicate: the single a, the single b, the single c, a combination of a and b, a combination of a and c, a combination of b and c, or a combination of a, b, and c, wherein each of a, b, and c may be single or plural. In addition, the terms “first,” “second,” and the like are merely for the illustration purpose, and shall not be construed as indicating or implying a relative importance.

In the description of the present disclosure, it should be understood that the terms “central,” “transversal,” “longitudinal,” “upper,” “lower,” “left,” “right,” “front,” “rear,” and the like indicate orientations and position relationships which are based on the illustrations in the accompanying drawings, and these terms are merely for ease and brevity of the description, instead of indicating or implying that the devices or elements shall have a particular orientation and shall be structured and operated based on the particular orientation. Accordingly, these terms shall not be construed as limiting the present disclosure.

In the description of the present disclosure, unless otherwise explicitly specified and defined, the terms “connected,” “coupled,” and derivatives forms thereof shall be understood in a broad sense. For example, the terms “connected,” “coupled,” and derivatives form thereof for depicting the circuit structure, in addition to physical connection, may also be understood as electrical connections or signal connection. The connection, for example, may be direct connection, i.e., the physical connection or, indirect connection via at least one intermediate element as long as the circuit is conducted, or communication between the interiors of two elements. The signal connection, in addition to signal connection via a circuitry, may also be signal connection via a communication medium, for example, radio waves. Persons of ordinary skill in the art may understand specific meanings of the above terms in the present disclosure according to the actual circumstances and contexts.

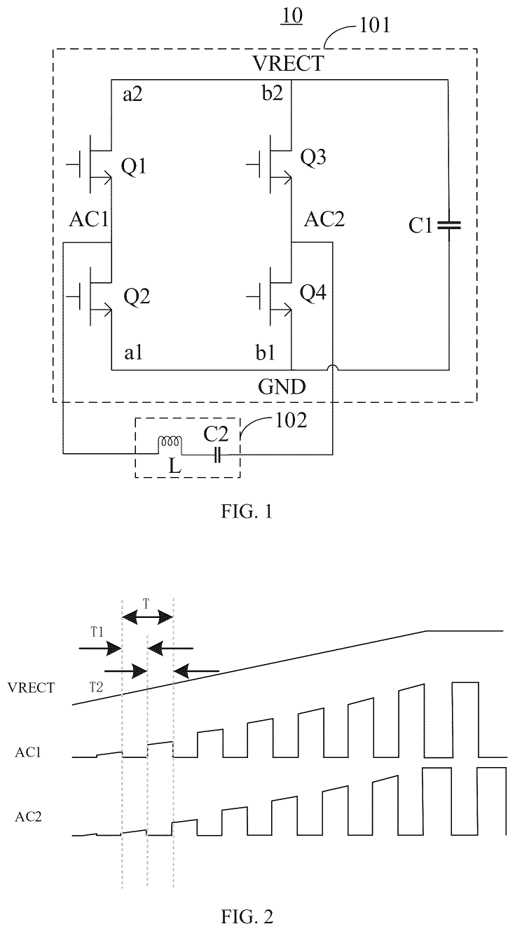

With the development of science and technology, electronic devices may be charged using a wireless charging system. The wireless charging system includes a wireless charging transmitter and a wireless charging receiver. The wireless charging receiver includes a wireless charging receiver circuit. The wireless charging receiver circuit is arranged in the electronic device. FIG. 1 is a schematic structural diagram of a wireless charging receiver circuit 10. As illustrated in FIG. 1, the wireless charging receiver circuit 10 includes a rectifier circuit 101 and a resonant circuit 102. The rectifier circuit 101 includes a first switch transistor Q1, a second switch transistor Q2, a third switch transistor Q3, a fourth switch transistor Q4, and a first capacitor C1. A second terminal of the first switch transistor Q1 is electrically connected to a first terminal of the second switch transistor Q2, a second terminal of the third switch transistor Q3 is electrically connected to a first terminal of the fourth switch transistor Q4, a second terminal of the second switch transistor Q2 and a second terminal of the fourth switch transistor Q4 are both grounded, and a first terminal of the first switch transistor Q1 and a first terminal of the third switch transistor Q3 are both electrically connected to an output terminal of the wireless charging receiver circuit 10. The first terminal of the third switch transistor Q3 is further grounded via the first capacitor C1. Specifically, the first terminal of the third switch transistor Q3 is electrically connected to a first terminal of the first capacitor C1, and a second terminal of the first capacitor C1 is grounded.

A point between the first switch transistor Q1 and the second switch transistor Q2 is defined as a first midpoint AC1, and a point between the third switch transistor Q3 and the fourth switch transistor Q4 is defined as a second midpoint AC2. The first midpoint AC1 is electrically connected to the second midpoint AC2 via the resonant circuit 102.

Furthermore, the first midpoint AC1 may be a midpoint between the first switch transistor Q1 and the second switch transistor Q2, or the first midpoint AC1 may be any point between the first switch transistor Q1 and the second switch transistor Q2.

Furthermore, the second midpoint AC2 may be a midpoint between the third switch transistor Q3 and the fourth switch transistor Q4, or the second midpoint AC2 may be any point between the third switch transistor Q3 and the fourth switch transistor Q4.

In some embodiments, the first switch transistor Q1, the second switch transistor Q2, the third switch transistor Q3, and the fourth switch transistor Q4 may all be NMOS transistors. In some other embodiments, the first switch transistor Q1 and the third switch transistor Q3 are PMOS transistors, and the second switch transistor Q2 and the fourth switch transistor Q4 are NMOS transistors.

In a case that the first switch transistor Q1, the second switch transistor Q2, the third switch transistor Q3, and the fourth switch transistor Q4 are all NMOS transistors, the first terminal of the first switch transistor Q1, the first terminal of the second switch transistor Q2, the first terminal of the third switch transistor Q3, and the first terminal of the fourth switch transistor Q4 are all drain electrodes of the NMOS transistors; and the second terminal of the first switch transistor Q1, the second terminal of the second switch transistor Q2, the second terminal of the third switch transistor Q3, and the second terminal of the fourth switch transistor Q4 are all source electrodes of the NMOS transistors.

In the present disclosure, description is given by an example where the first switch transistor Q1, the second switch transistor Q2, the third switch transistor Q3, and the fourth switch transistor Q4 are all NMOS transistors.

As illustrated in FIG. 1, the resonant circuit 102 includes a receiver coil L and a second capacitor C2. A first terminal of the receiver coil L is electrically connected to the first point AC1, a second terminal of the receiver coil L is electrically connected to a first terminal of the second capacitor C2, and a second terminal of the second capacitor C2 is electrically connected to the second midpoint AC2. The receiver coil L is magnetically coupled to a transmitter coil in the wireless charging transmitter and electrically connected to the rectifier circuit 101, and is configured to receive an alternating current signal from the transmitter coil and transmit the alternating current signal to the rectifier circuit 101; and the rectifier circuit 101 is configured to convert the alternating current signal to a direct current charging signal for output.

Specifically, the transmitter coil in the wireless charging transmitter transmits an electromagnetic wave to the receiver coil L in the resonant circuit 102, the receiver coil L senses changes in an electromagnetic field and generates an alternating current signal, and the alternating current signal is compensated by the second capacitor C2, such that compensation and correction of the alternating current signal are achieved. Afterwards, the alternating current signal is output to the rectifier circuit 101 via the first midpoint AC1 and the second midpoint AC2. The rectifier circuit 101 is configured to convert the alternating current signal to a direct current charging signal, and output the direct current charging signal via an output terminal of the rectifier circuit 101, such that a power consuming device is charged based on the direct current charging signal. The output terminal of the rectifier circuit 101 may act as the output terminal of the wireless charging receiver circuit 10.

As illustrated in FIG. 1, in response to receiving a signal from the wireless charging transmitter, the wireless charging receiver circuit 10 starts, and the rectifier circuit 101 operates in a full bridge mode. In the full bridge mode, a set of switch transistors formed by the first switch transistor Q1 and the fourth switch transistor Q4 and a set of switch transistors formed by the second switch transistor Q2 and the third switch transistor Q3 are alternately turned on under the effect of body diodes thereof, the first capacitor C1 is slowly charged, such that the alternating current signal output by the resonant circuit 102 is converted to the direct current charging signal for output.

FIG. 2 illustrates schematic waveforms of voltage signals at the output terminal VRECT, the first midpoint AC1, and the second midpoint AC2 in the wireless charging receiver circuit 10 in the full bridge mode.

As illustrated in FIG. 2, the first capacitor C1 is slowly charged, such that the voltage at the output terminal VRECT in the wireless charging receiver circuit 10 slowly increases to a maximum value and is maintained stable.

A cycle of the alternating current signal output by the resonant circuit 102 may be divided into a first half cycle and a second half cycle. As illustrated in FIG. 2, one cycle is marked as T, wherein the first half cycle is T1, and the second half cycle is T2. Signals within the first half cycle T1 and the second half cycle T2 have opposite phases. Signals within the first half cycle T1 and the second half cycle T2 having opposite phases means that a phase difference of the signal between the first half cycle and the second half cycle is 180°.

In the full bridge mode, no drive signal is applied to control terminals of the first switch transistor Q1 to the fourth switch transistor Q4, and the first switch transistor Q1 to the fourth switch transistor Q4 are controlled to be turned on or turned off via the body diodes thereof. As illustrated in FIG. 2, within the first half cycle T1 of the alternating current signal, the second switch transistor Q2 and the third switch transistor Q3 are turned on, the first switch transistor Q1 and the fourth switch transistor Q4 are turned off, the second midpoint AC2 outputs a high-level signal, and the first midpoint AC1 outputs a low-level signal. By ignoring thread voltages of the body diodes, a voltage of the high-level signal output by the second midpoint AC2 is substantially equal to a voltage at the output terminal.

The control terminal of the first switch transistor Q1 is a gate electrode thereof, the control terminal of the second switch transistor Q2 is a gate electrode thereof, the control terminal of the third switch transistor Q3 is a gate electrode thereof, and the control terminal of the fourth switch transistor Q4 is a gate electrode thereof.

As illustrated in FIG. 2, within the second half cycle T2 of the alternating current signal, the first switch transistor Q1 and the fourth switch transistor Q4 are turned on, the second switch transistor Q2 and the third switch transistor Q3 are turned off, the first midpoint AC1 outputs a high-level signal, and the second midpoint AC2 outputs a low-level signal. Where a threshold voltage of the diode is ignored, the voltage of the high-level signal output by the first midpoint AC1 is substantially equal to the voltage at the output terminal. Where the threshold voltage of the diode is not ignored, the voltage of the high-level signal output by the first midpoint AC1 is higher than the voltage of the body diode relative to the voltage at the output terminal.

The rectifier circuit in the wireless charging receiver circuit 10 may operate in the full bridge mode or operate in the half bridge mode. The full bridge mode, as described above, refers to a mode in which the rectifier circuit controls the four switch transistors to be alternately turned on in groups to convert the alternating current signal into the direct current signal.

The half bridge mode refers to a mode in which the rectifier circuit controls the first switch transistor Q1 and the second switch transistor Q2 to be alternately turned on, and controls the second switch transistor Q2 or the fourth switch transistor Q4 to be constantly in a turned-on state to cause the first midpoint AC1 to be grounded or the second midpoint AC2 to be grounded such that the alternating current signal is converted to the direct current signal.

In a case that the rectifier circuit operates in the half bridge mode, the voltage at the output terminal of the wireless charging receiver circuit 10 is higher over the voltage at the output terminal of the wireless charging receiver circuit 10 in a case that the rectifier circuit operates in the full bridge mode. In some embodiments, the wireless charging receiver circuit 10 operates in the half bridge mode, the voltage at the output terminal of the wireless charging receiver circuit 10 is twice the voltage thereof in the full bridge mode.

In some embodiments, a half-bridge startup circuit may be arranged. The voltage at the output terminal of the wireless charging receiver circuit 10 is converted using the half-bridge startup circuit, such that a drive signal is supplied to the second switch transistor Q2 or the fourth switch transistor Q4 to control the fourth switch transistor Q4 or the second switch transistor Q2 to remain a turned-on state, and the rectifier circuit switches from the full bridge mode to the half bridge mode.

In a case that a half-bridge startup circuit is arranged with respect to the fourth switch transistor Q4, after the fourth switch transistor Q4 is turned on, the first switch transistor Q1 and the second switch transistor Q2 are alternately turned on. In a case that a half-bridge startup circuit is arranged with respect to the second switch transistor Q2, after the second switch transistor Q2 is turned on, the third switch transistor Q3 and the fourth switch transistor Q4 are alternately turned on.

Specifically, after the fourth switch transistor Q4 is turned on, the first switch transistor Q1 and the second switch transistor Q2 are alternately turned on, such that the wireless charging receiver circuit 10 operates in the half bridge mode.

After the second switch transistor Q2 is turned on, the third switch transistor Q3 and the fourth switch transistor Q4 are alternately turned on, such that the wireless charging receiver circuit 10 operates in the half bridge mode.

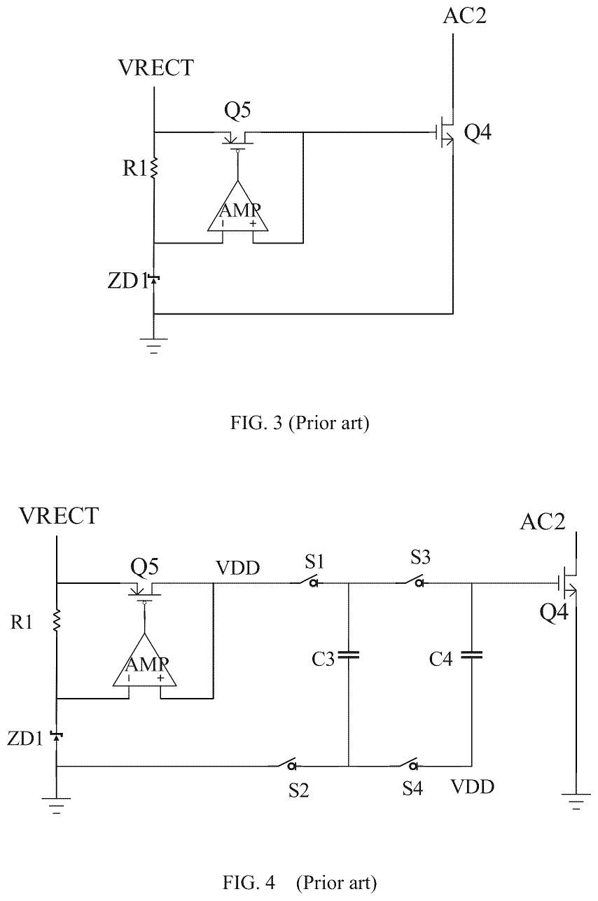

In one related art, as illustrated in FIG. 3, the half-bridge startup circuit includes a first resistor R1, a fifth switch transistor Q5, an operational amplifier AMP, and a first Zener diode ZD1. The fifth switch transistor Q5 is a PMOS transistor. A connection relationship between the half-bridge startup circuit and the fourth switch transistor Q4 in the wireless charging receiver circuit 10 is as illustrated in FIG. 3. A terminal of the first resistor R1, as the output terminal VRECT of the wireless charging receiver circuit 10, is electrically connected to a source electrode of the fifth switch transistor Q5, and another terminal of the first resistor R1 is grounded via the first Zener diode ZD1. A drain electrode of the fifth switch transistor Q5 is electrically connected to a non-inverting input terminal of the operational amplifier AMP, and an inverting input terminal of the operational amplifier is electrically connected to a point between the first resistor R1 and the first Zener diode ZD1. The drain electrode of the fifth switch transistor Q5 is further electrically connected to the control terminal of the fourth switch transistor Q4. The half-bridge startup circuit may provide a drive voltage to the control terminal of the fourth switch transistor Q4 to drive the fourth switch transistor Q4 to be turned on.

In the half-bridge startup circuit as illustrated in FIG. 3, a voltage input to the control terminal of the fourth switch transistor Q4 is equal to the voltage at the output terminal VRECT in the wireless charging receiver circuit 10. In some special scenarios, for example, the coils in the wireless charging receiver circuit are far away from the coils in the wireless charging transmitter circuit, or their positions are not well aligned, and consequently, the voltage at the output terminal of the wireless charging receiver circuit is relatively low and thus the voltage input to the control terminal of the fourth switch transistor Q4 is too low to reach a threshold voltage of the fourth switch transistor Q4, the fourth switch transistor Q4 fails to be turned on, the rectifier circuit may fail to switch to the half bridge mode or fail to stably operate in the half bridge mode, and hence the charging requirement of the electronic device fails to be satisfied.

In another related art, as illustrated in FIG. 4, the half-bridge startup circuit includes a first resistor R1, a fifth switch transistor Q5, a first Zener diode ZD1, an operational amplifier AMP, a first switch S1, a second switch S2, a third switch S3, a third capacitor C3, and a fourth capacitor C4. The fifth switch transistor Q5 is a PMOS transistor. A terminal of the first resistor R1, as the output terminal VRECT of the wireless charging receiver circuit 10, is electrically connected to a source electrode of the fifth switch transistor Q5, and another terminal of the first resistor R1 is grounded via the first Zener diode ZD1. A drain electrode of the fifth switch transistor Q5 is electrically connected to a non-inverting input terminal of the operational amplifier AMP, and an inverting input terminal of the operational amplifier is electrically connected to a point between the first resistor R1 and the first Zener diode ZD1. The drain electrode of the fifth switch transistor Q5 is electrically connected to a first terminal of the first switch S1, a second terminal of the first switch S1 is electrically connected to a first terminal of the third switch S3, a second terminal of the third switch S3 is electrically connected to a first terminal of the fourth switch S4 via the fourth capacitor, and a second terminal of the fourth switch S4 is grounded via the second switch S2. A point between the fourth switch S4 and the second switch S2 is electrically connected to the second terminal of the first switch S1 via the third capacitor C3. The half-bridge startup circuit may provide a drive voltage to the control terminal of the fourth switch transistor Q4 to drive the fourth switch transistor Q4 to be turned on.

In the half-bridge startup circuit as illustrated in FIG. 4, a large number of devices are used, and the circuit has a relatively high internal resistance, a complex structure, and requires sophisticated logic control, making the design more challenging.

Accordingly, some embodiments of the present disclosure provide a half-bridge startup circuit 20. The half-bridge startup circuit 20, as compared with the related art, is capable of implementing half-bridge startup based on a lower voltage at the receiver, such that the charging efficiency is improved.

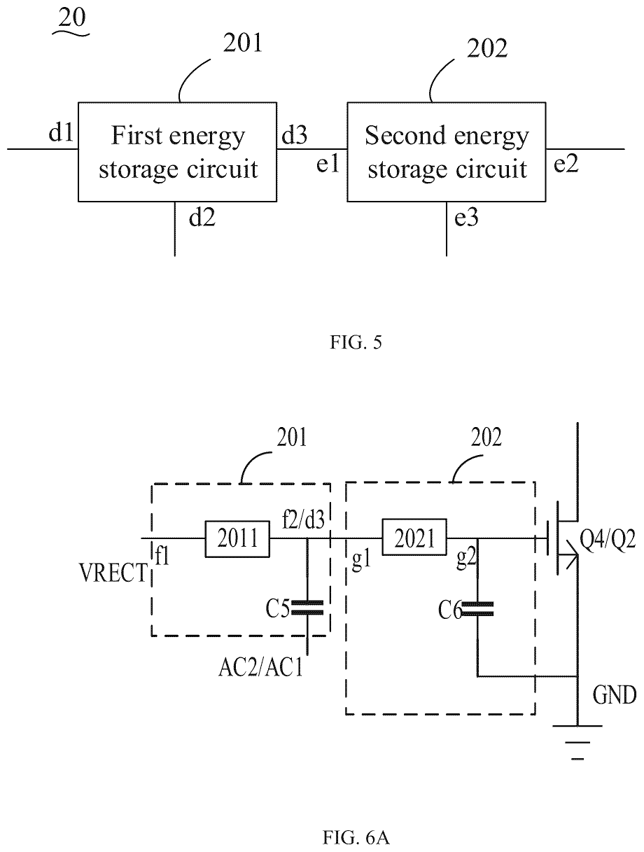

FIG. 5 is a schematic structural diagram of a half-bridge startup circuit 20 according to some embodiments of the present disclosure. The half-bridge startup circuit 20 includes a first energy storage circuit 201 and a second energy storage circuit 202.

A first terminal d1 of the first energy storage circuit 201 is electrically connected to the output terminal VRECT of the wireless charging receiver circuit 10, a second terminal d2 of the first energy storage circuit 201 is electrically connected to a target midpoint, and a third terminal d3 of the first energy storage circuit 201 is electrically connected to a first terminal e1 of the second energy storage circuit 202, a second terminal e2 of the second energy storage circuit 202 is electrically connected to a control terminal of a target switch transistor, and a third terminal e3 of the second energy storage circuit 202 is grounded.

The target midpoint is related to the target switch transistor. In a case that the target switch transistor is the second switch transistor Q2, the target midpoint is the second midpoint AC2. In a case that the target switch transistor is the fourth switch transistor Q4, the target midpoint is the first midpoint AC1.

The resonant circuit 102 in the wireless charging receiver circuit 10 outputs an alternating current signal. Each cycle of the alternating current signal includes a first half cycle and a second half cycle. Phase directions of the signal within the first half cycle and the second half cycle are different.

Within the first half cycle of the alternating current signal, the first energy storage circuit 201 is charged based on a voltage at the output terminal VRECT of the wireless charging receiver circuit 10 and a voltage at the target midpoint, such that a first voltage difference V_{d2-d3} between the second terminal d2 and the third terminal d3 of the first energy storage circuit 201 increases.

Within the second half cycle of the alternating current signal, the first energy storage circuit 201 is discharged to transmit electric energy to the second energy storage circuit 202, such that a second voltage difference Vₑ₂₋ₑ₃ between the second terminal e2 and the third terminal e3 of the second energy storage circuit 202 increases.

Since the third terminal e3 is grounded, Vₑ₂₋ₑ₃=Vₑ₂.

In a case that the second voltage difference Vₑ₂₋ₑ₃ is greater than a threshold voltage of the target switch transistor, the target switch transistor is turned on, and the second midpoint AC2 is grounded. Another switch transistor on the same bridge arm as the target switch transistor is not turned on, and two switch transistors on a bridge arm not including the target switch transistor in the rectifier circuit 101 are alternately turned on to convert the alternating current signal output by the resonant circuit 102 to the direct current charging signal. As illustrated in FIG. 5, the first switch transistor Q1 and the second switch transistor Q2 are connected in series to form a bridge arm, and the third switch transistor Q3 and the fourth switch transistor Q4 are connected in series to form a bridge arm; and in this case, the first switch transistor Q1 and the second switch transistor Q2 are switch transistors belonging to the same bridge arm, and the third switch transistor Q3 and the fourth switch transistor Q4 are switch transistors belonging to the same bridge arm.

In a case that the target switch transistor is turned on, the second voltage difference Vₑ₂₋ₑ₃ is greater than the voltage at the output terminal VRECT of the wireless charging receiver circuit in the full bridge mode.

Hereinafter, the operating state of the wireless charging receiver circuit 10 in the half bridge mode is described by an example where the target switch transistor is the fourth switch transistor Q4.

The second voltage difference is greater than the threshold voltage of the fourth switch transistor Q4, the fourth switch transistor Q4 is turned on, and the rectifier circuit 101 operates in the half bridge mode. In the half bridge mode, the fourth switch transistor Q4 is constantly maintained in a turned-on state, and the third switch transistor Q3 is constantly maintained in a turned-off state. The first switch transistor Q1 and the second switch transistor Q2 are alternately turned on, such that the rectifier circuit 101 converts a voltage signal output by the resonant circuit 102 to a direct current charging signal.

In the half-bridge startup circuit 20 according to the present disclosure, within the first half cycle, the first energy storage circuit 201 is in a charging state, such that the first voltage difference between the second terminal d2 and the third terminal d3 of the first energy storage circuit 201 increases; and within the second half cycle, the first energy storage circuit 201 is discharged to transmit electric energy to the second energy storage circuit 202, such that the second voltage difference between the second terminal e2 and the third terminal e3 of the second energy storage circuit 202 increases. In a case that the second voltage difference is greater than a threshold voltage of the target switch transistor, the target switch transistor is turned on, such that the rectifier circuit 101 in the wireless charging receiver circuit 10 operates in a half bridge mode. In a case that the target switch transistor is turned on, an absolute value of the second voltage difference is greater than an output voltage the wireless charging receiver circuit 10, that is, a half-bridge startup voltage boosts the output voltage of the wireless charging receiver circuit 10, such that switching from the full bridge mode to the half bridge mode using a lower output voltage, and the rectifier circuit stably operates in the half bridge mode.

In some embodiments, the first energy storage circuit 201 includes a first unidirectional conducting branch and a first storage branch. A current ON direction supported on the first unidirectional conducting branch is from a first terminal of the first unidirectional conducting branch to a second terminal of a first terminal of the second unidirectional conducting branch. The first terminal of the first unidirectional conducting branch is electrically connected to the output terminal of the wireless charging receiver circuit.

The first unidirectional conducting branch includes a first unidirectional conducting device. A first terminal of the first unidirectional conducting device, as the first terminal of the unidirectional conducting branch, is electrically connected to the output terminal of the wireless charging receiver circuit 10.

The first energy storage branch includes one or a plurality of fifth capacitors. In a case that the first energy storage branch includes one fifth capacitors, a second terminal of the first unidirectional conducting device, as the second terminal of the first unidirectional conducting branch, is electrically connected to a first terminal of the fifth capacitor, and a second terminal of the fifth capacitor is electrically connected to the target midpoint; or in a case that the first energy storage branch includes a plurality of fifth capacitors that are connected in series, a second terminal of the first unidirectional conducting device, as the second terminal of the first unidirectional conducting branch, is electrically connected to a first terminal of a 1^{st} fifth capacitor in the plurality of fifth capacitors that are connected in series, and a second terminal of a last fifth capacitor in the plurality of fifth capacitors that are connected in series is electrically connected to the target midpoint.

In the plurality of fifth capacitors that are connected in series, a second terminal of an i^{th} fifth capacitor is electrically connected to a first terminal of an (i+1)^{th} fifth capacitor. i is greater than or equal to 1, and is less than N; and Nis the number of fifth capacitors.

In some embodiments, the second energy storage circuit 202 includes a second unidirectional conducting branch and a second energy storage branch. A current ON direction supported on the second unidirectional conducting branch is from a first terminal of the second unidirectional conducting branch to a second terminal of the second unidirectional conducting branch. A first terminal of the second unidirectional conducting branch is electrically connected to the second terminal of the first unidirectional conducting branch, and a second terminal of the second unidirectional conducting branch is electrically connected to the target switch transistor.

In a case that the second energy storage branch includes one sixth capacitor, the second terminal of the second unidirectional conducting branch is electrically connected to a first terminal of the sixth capacitor, and a second terminal of the sixth capacitor is grounded; or in a case that the second energy storage branch includes a plurality of sixth capacitors that are connected in series, the second terminal of the second unidirectional conducting branch is electrically connected to a first terminal of a 1^{st} sixth capacitor in the plurality of sixth capacitors that are connected in series, and a second terminal of a last sixth capacitor in the plurality of sixth capacitors that are connected in series is grounded.

A second terminal of a j^{th} sixth capacitor in the plurality of sixth capacitors that are connected in series is electrically connected to a first terminal of a (j+1)^{th} sixth capacitor in the plurality of sixth capacitors that are connected in series. i is greater than or equal to 1, and is less than M; and M is the number of sixth capacitors.

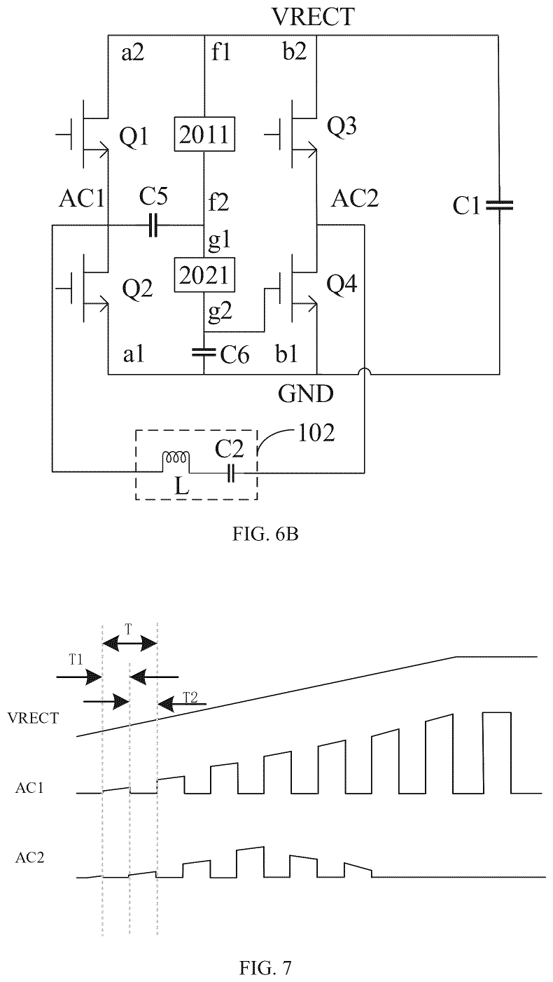

Exemplarily, the structure of the half-bridge startup circuit 20 is described by an example where one fifth capacitor and one sixth capacitor are arranged. FIG. 6A illustrates a schematic structural diagram of a first energy storage circuit 201 and a second energy storage circuit 202 in the half-bridge startup circuit 20 in a case that one fifth capacitor and one sixth capacitor are arranged. As illustrated in FIG. 6A, the first energy storage circuit 201 includes a first unidirectional conducting device 2011 and a fifth capacitor C5; and the second energy storage circuit 202 includes a second unidirectional conducting device 2021 and a sixth capacitor C6.

A first terminal of the first unidirectional conducting device 2011, as the first terminal f1 of the first unidirectional conducting branch, is electrically connected to the output terminal VRECT of the wireless charging receiver circuit 10, a second terminal of the first unidirectional conducting device 2011, as the third terminal d3 of the first energy storage circuit 201, is electrically connected to a first terminal of the fifth capacitor C5, and a second terminal of the fifth capacitor C5 is electrically connected to the first midpoint AC1 or the second midpoint AC2.

Specifically, in a case that the target switch transistor is the second switch transistor Q2, the second terminal of the fifth capacitor C5 is electrically connected to the second midpoint AC2; or in a case that the target switch transistor is the fourth switch transistor Q4, the second terminal of the fifth capacitor C5 is electrically connected to the first midpoint AC1.

A first terminal of the second unidirectional conducting device 2021, as the first terminal g1 of the second unidirectional conducting branch, is electrically connected to the second terminal of the first unidirectional conducting device 2011; a second terminal of the second unidirectional conducting device 2021, as the second terminal g2 of the second unidirectional conducting branch, is electrically connected to a first terminal of the sixth capacitor C6; a second terminal of the sixth capacitor C6 is grounded; and the second terminal of the second unidirectional conducting device 2021 is further electrically connected to the control terminal of the second switch transistor Q2 or the control terminal of the fourth switch transistor Q4.

Specifically, in a case that the target switch transistor is the second switch transistor Q2, the second terminal of the second unidirectional conducting device 2021 is electrically connected to the control terminal of the second switch transistor Q2. In a case that the target switch transistor is the fourth switch transistor Q4, the second terminal of the second unidirectional conducting device 2021 is electrically connected to the control terminal of the fourth switch transistor Q4.

In FIG. 6A, within the first half cycle of the alternating current signal, the first unidirectional conducting branch is in an ON state, the fifth capacitor C5 of the first energy storage branch is charged based on the voltage at the output terminal VRECT of the wireless charging receiver circuit 10 and the voltage at the target midpoint, such that a voltage difference between two terminals of the first energy storage branch increases.

Within the second half cycle of the alternating current signal, the second unidirectional conducting branch is in an ON state, the sixth capacitor C6 of the second energy storage branch is charged based on a voltage at the third terminal d3 of the first energy storage circuit 201, such that a voltage difference between two terminals of the second energy storage branch increases. In a case that the voltage difference between the two terminals of the second energy storage branch is greater than the threshold voltage of the target switch transistor, the target switch transistor is turned on, such that the rectifier circuit 101 operates in the half bridge mode. In a case that the target switch transistor is turned on, the voltage difference between the two terminals of the second energy storage branch is greater than a direct current charging voltage at the output terminal.

Hereinafter, how the half-bridge startup circuit boots the output voltage of the wireless charging receiver circuit 10 to a voltage to cause the target switch transistor to be turned on is described by examples where the target switch transistor is the fourth switch transistor Q4 and the target switch transistor is the second switch transistor Q2 respectively.

For clear and intuitive illustration of the connection relationship between the half-bridge startup circuit and the wireless charging receiver circuit, in the present disclosure, the half-bridge startup circuit and the wireless charging receiver circuit 10 are exhibited in the same diagram. FIG. 6B illustrates a connection relationship between the wireless charging receiver circuit 10 and the half-bridge startup circuit 20 in a case that the target switch transistor is the fourth switch transistor Q4. The half-bridge startup circuit 20 is as illustrated in FIG. 6A. The half-bridge startup circuit 20 includes a first unidirectional conducting device 2011, a second unidirectional conducting device 2021, a fifth capacitor C5, and a sixth capacitor C6. Specifically, as illustrated in FIG. 6A, a first terminal f1 of the first unidirectional conducting device 2011 is electrically connected to the output terminal VRECT of the wireless charging receiver circuit 10, a second terminal f2 of the first unidirectional conducting device 2011 is electrically connected to the first midpoint AC1 via the fifth capacitor C5, the second terminal f2 of the first unidirectional conducting device 2011 is further electrically connected to a first terminal of the sixth capacitor C6 via the second unidirectional conducting device 2021, and a second terminal of the sixth capacitor C6 is grounded. A point between the second unidirectional conducting device 2021 and the sixth capacitor C6 is electrically connected to the control terminal of the fourth switch transistor Q4.

FIG. 7 illustrates schematic waveforms of voltage signals at the output terminal VRECT, the first midpoint AC1, and the second midpoint AC2 in the wireless charging receiver circuit 10 in a half bridge startup process in a case that the target switch transistor is the fourth switch transistor Q4.

In a case that the target switch transistor is the fourth switch transistor Q4, within the first half cycle T1, the second switch transistor Q2 and the third switch transistor Q3 are turned on, the first switch transistor Q1 and the fourth switch transistor Q4 are turned off, and a voltage at the first midpoint AC1 is a low level. Therefore, the fifth capacitor C5 is charged, such that V_{f2}-V_{AC1}=V_{C5}=V_{VRECT}. V_{AC1} is a voltage of the body diode of the second switch transistor Q2 in a case that the second switch transistor Q2 is turned on. Within the second half cycle T2, the second switch transistor Q2 and the third switch transistor Q3 are turned off, the first switch transistor Q1 and the fourth switch transistor Q4 are turned on, and a voltage at the first midpoint AC1 is a high level, such that V_{AC1}=V_{VRECT}+V_{D1}, V_{f2}=V_{AC1}+V_{C5}=2V_{VRECT}+V_{D1}. V_{D1} is a voltage of the body diode of the second switch transistor Q2 in a case that the second switch transistor Q2 is turned on. Therefore, the sixth capacitor C6 of the second energy storage branch is charged, such that a voltage difference between two terminals of the sixth capacitor C6 increases, and V_{f2} decreases, until the second half cycle T2 ends.

After this process is repeated for multiple cycles T, the sixth capacitor C6 is repeatedly charged, until the voltage difference between the two terminals of the sixth capacitor C6 is equal to the threshold voltage of the target switch transistor, then the target switch transistor is turned on.

The rectifier circuit 101 initially operates in the full bridge mode, the output voltage exhibits a gradual increase. Before the fourth switch transistor Q4 is turned on, waveforms of voltages at the first midpoint AC1 and the second midpoint AC2 are the same as those in FIG. 2. In a case that the fourth switch transistor Q4 is turned on, the second midpoint AC2 is shorted to the ground, and the voltage thereof gradually decreases to 0.

In a case that the target switch transistor is the second switch transistor Q2, within the first half cycle T1, the second switch transistor Q2 and the third switch transistor Q3 are turned off, the first switch transistor Q1 and the fourth switch transistor Q4 are turned on, and the second midpoint AC2 is at a low level. Therefore, the fifth capacitor C5 is charged, such that V_{f2}−V_{AC2}=V_{C5}=V_{VRECT}. V_{AC2} is a voltage of the body diode of the fourth switch transistor Q4 in a case that the fourth switch transistor Q4 is turned on. Within the second half cycle T2, the second switch transistor Q2 and the third switch transistor Q3 are turned on, the first switch transistor Q1 and the fourth switch transistor Q4 are turned off, and the second midpoint AC2 is at a high level, such that V_{AC2}=V_{VRECT}+V_{D2}, V_{f2}=V_{AC2}+V_{C5}=2V_{VRECT}+V_{D2}. V_{D2} is a voltage of the body diode of the fourth switch transistor Q4 in a case that the fourth switch transistor Q4 is turned on. Therefore, the sixth capacitor C6 on the second energy storage branch is charged, such that a voltage difference between two terminals of the sixth capacitor C6 increases, and V_{f2} decreases, until the second half cycle T2 ends.

After this process is repeated for multiple cycles T, the sixth capacitor C6 is repeatedly charged, until the voltage difference between the two terminals of the sixth capacitor C6 is equal to a maximum value, i.e., 2V_{VRECT}, of the voltage at the second terminal f2 of the first unidirectional conducting branch. In a case that the voltage difference between the two terminals of the sixth capacitor C6 is equal to the threshold voltage of the target switch transistor, the target switch transistor is turned on. Generally, V_{D2} is very small, which may be ignored.

It is apparent that through multiple cycles, as illustrated in FIG. 6A, the sixth capacitor C6 is repeatedly charged, and since the second unidirectional conducting branch is one-direction turned on, the ON direction is from the first terminal g1 of the second unidirectional conducting branch to the second terminal g2 of the second unidirectional conducting branch. Therefore, the sixth capacitor C6 only receives charges of a current flowing in the direction from the second terminal f2 of the first unidirectional conducting branch to the first direction g1 of the second unidirectional conducting branch, but does not discharge in the direction from the first terminal g1 of the second unidirectional conducting branch to the second terminal f2 of the first unidirectional conducting branch. Therefore, a maximum voltage of the charged sixth capacitor C6 may reach the maximum voltage (i.e., 2V_{VRECT}) at the second terminal f2 of the first unidirectional conducting branch. Accordingly, the half-bridge startup circuit 20 is capable of doubling the voltage of the output terminal VRECT, such that the rectifier circuit 10 is capable of achieving half-bridge startup under an even lower output voltage.

In some embodiments, the first unidirectional conducting device 2011 in the first unidirectional conducting branch may be a first diode or a first field-effect transistor. The first field-effect transistor may be an NMOS transistor or a PMOS transistor. In some embodiments, the second unidirectional conducting device 2021 in the second unidirectional conducting branch may be a second diode or a second field-effect transistor. The second field-effect transistor may be an NMOS transistor or a PMOS transistor.

In a case that the first unidirectional conducting device 2011 is the first diode, a positive electrode of the first diode, as the first terminal f1 of the first unidirectional conducting branch, is electrically connected to the output terminal VRECT of the wireless charging receiver circuit. In a case that the first energy storage circuit 202 includes one fifth capacitor C5, a negative electrode of the first diode, as the second terminal f2 of the first unidirectional conducting branch, is electrically connected to a first terminal of the fifth capacitor C5; or in a case that the first energy storage circuit 202 includes a plurality of fifth capacitors C5 that are connected in series, the negative electrode of the first diode is electrically connected to a first terminal of a 1^{st} fifth capacitor C5 in the plurality of fifth capacitors C5 that are connected in series.

In a case that the first unidirectional conducting device 2011 is an NMOS transistor, a substrate of the NMOS transistor is electrically connected to a gate electrode of the NMOS transistor, the gate electrode of the NMOS transistor is electrically connected to a source electrode of the NMOS transistor, and the source electrode of the NMOS transistor, as the first terminal f1 of the first unidirectional conducting branch, is electrically connected to the output terminal of the wireless charging receiver circuit 10. A drain electrode of the NMOS transistor, as the second terminal f2 of the first unidirectional conducting branch, is electrically connected to the first terminal of the fifth capacitor C5, or electrically connected to the first terminal of the 1^{st} fifth capacitor C5 in the plurality of fifth capacitors C5 that are connected in series.

In a case that the first unidirectional conducting device 2011 is a PMOS transistor, a substrate of the PMOS transistor is electrically connected to a gate electrode of the PMOS transistor, the gate electrode of the PMOS transistor is electrically connected to a source electrode of the PMOS transistor, a drain electrode of the PMOS transistor, as the first terminal f1 of the first unidirectional conducting branch, is electrically connected to the output terminal of the wireless charging receiver circuit 10, and a source electrode of the PMOS transistor, as the second terminal f2 of the first unidirectional conducting branch, is electrically connected to the first terminal of the fifth capacitor C5 or is electrically connected to the first terminal of the 1^{st} fifth capacitor C5 in the plurality of fifth capacitors C5 that are connected in series.

In a case that the second unidirectional conducting device 2021 is a second diode, a positive electrode of the second diode, as the first terminal g1 of the second unidirectional conducting branch, is electrically connected to the third terminal d3 of the first energy storage circuit, and a negative electrode of the second diode, as the second terminal g2 of the second unidirectional conducting branch, is electrically connected to the control terminal of the target switch transistor.

A negative electrode of the second diode is further electrically connected to the first terminal of the fifth capacitor, or electrically connected to the first terminal of the 1^{st} fifth capacitor in the plurality of fifth capacitors that are connected in series.

In a case that the second unidirectional conducting device 2021 is an NMOS transistor, a substrate of the NMOS transistor is electrically connected to a gate electrode of the NMOS transistor, the gate electrode of the NMOS transistor is electrically connected to a source electrode of the NMOS transistor, the source electrode of the NMOS transistor, as the first terminal g1 of the second unidirectional conducting branch, is electrically connected to the third terminal d3 of the first energy storage circuit, and a drain electrode of the NMOS transistor, as the second terminal g2 of the second unidirectional conducting branch, is electrically connected to the control terminal of the target switch transistor.

In a case that the second unidirectional conducting device is a PMOS transistor, a substrate of the PMOS transistor is electrically connected to a gate electrode of the PMOS transistor, the gate electrode of the PMOS transistor is electrically connected to a source electrode of the PMOS transistor, a drain electrode of the PMOS transistor, as the first terminal g1 of the second unidirectional conducting branch, is electrically connected to the third terminal d3 of the first energy storage circuit, and a source electrode of the PMOS transistor, as the second terminal g2 of the second unidirectional conducting branch, is electrically connected to the control terminal of the target switch transistor.

Hereinafter, a schematic structural diagram of the first energy storage circuit 201 and the second energy storage circuit 202 in a case that the first unidirectional conducting device 2011 is a first diode VD1, the second unidirectional conducting device 2021 is a second diode VD2, and one fifth capacitor C5 and one sixth capacitor C6 are arranged is illustrated with reference to FIG. 8.

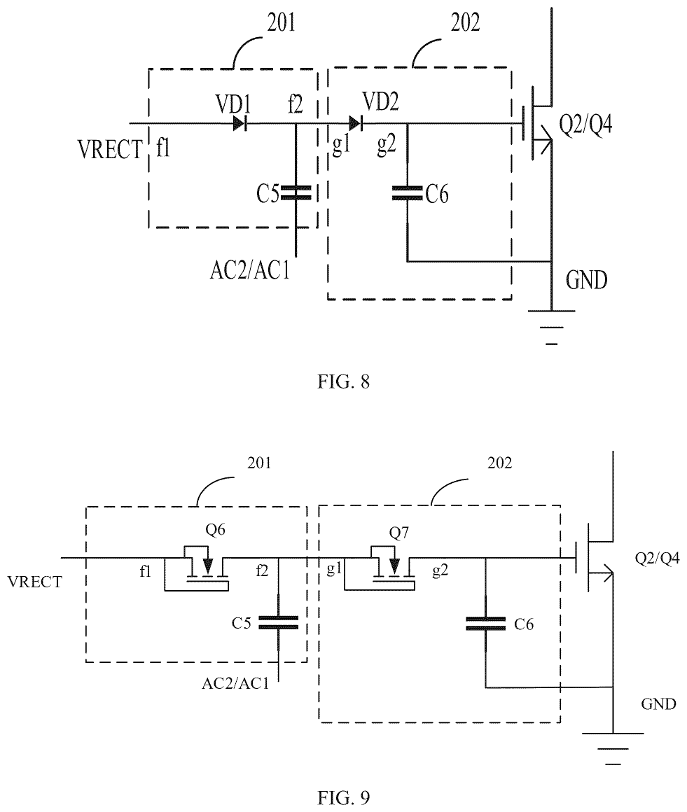

Hereinafter, a schematic structural diagram of the first energy storage circuit 201 and the second energy storage circuit 202 in a case that the first unidirectional conducting device 2011 is a first field-effect transistor Q6, the second unidirectional conducting device 2021 is a second field-effect transistor Q7, one fifth capacitor C5 and one sixth capacitor C6 are arranged, and the first field-effect transistor Q6 and the second field-effect transistor Q7 are both NMOS transistors is illustrated with reference to FIG. 9.

As illustrated in FIG. 8, the first unidirectional conducting device 2011 is the first diode VD1, and the second unidirectional conducting device 2021 is the second diode VD2. A positive electrode of the first diode VD1 is electrically connected to the output terminal VRECT of the wireless charging receiver circuit, a negative electrode of the first diode VD1 is electrically connected to a first terminal of the fifth capacitor C5, and a second terminal of the fifth capacitor C5 is electrically connected to the first midpoint AC1 or the second midpoint AC2. A positive electrode of the second diode VD2 is electrically connected to the negative electrode of the first diode VD1, a negative electrode of the second diode VD2 is electrically connected to a first terminal of the sixth capacitor C6, a second terminal of the sixth capacitor C6 is grounded, and the negative electrode of the second diode VD2 is further electrically connected to the control terminal of the second switch transistor Q2 or the control terminal of the fourth switch transistor Q4.

As illustrated in FIG. 9, the first unidirectional conducting device 2011 is a first field-effect transistor Q6 which is an NMOS transistor, and the second unidirectional conducting device 2022 is a second field-effect transistor Q7 which is an NMOS transistor. A substrate of the first field-effect transistor Q6 is electrically connected to a gate electrode of the first field-effect transistor Q6, the gate electrode of the first field-effect transistor Q6 is electrically connected to a source electrode of the first field-effect transistor Q6, a source electrode of the first field-effect transistor Q6 is electrically connected to the output terminal VRECT, a drain electrode of the first field-effect transistor Q6 is electrically connected to the first terminal of the fifth capacitor C5, the second terminal of the fifth capacitor C5 is electrically connected to the first midpoint AC1 or the second midpoint AC2, and the drain electrode of the first field-effect transistor Q6 is further electrically connected to a source electrode of the second field-effect transistor Q7. As such, the first field-effect transistor Q6 may be considered as a diode, the source electrode of the first field-effect transistor Q6 may be considered as an anode of the diode, and the drain electrode of the first field-effect transistor Q6 may be considered as a cathode of the diode.

A substrate of the second field-effect transistor Q7 is electrically connected to a gate electrode of the second field-effect transistor Q7, the gate electrode of the second field-effect transistor Q7 is electrically connected to a source electrode of the second field-effect transistor Q7, a drain electrode of the second field-effect transistor Q7 is electrically connected to the first terminal of the sixth capacitor C6, and the drain electrode of the second field-effect transistor Q7 is further electrically connected to the control terminal of the second switch transistor Q2 or the control terminal of the fourth switch transistor Q4. As such, the second field-effect transistor Q7 may be considered as a diode, the source electrode of the second field-effect transistor Q7 may be considered as an anode of the diode, and the drain electrode of the second field-effect transistor Q7 may be considered as a cathode of the diode.

In some embodiments, the first field-effect transistor Q6 and the second field-effect transistor Q7 may be both PMOS transistors. In a case that the first field-effect transistor Q6 and the second field-effect transistor Q7 are both PMOS transistors, a substrate of the first field-effect transistor Q6 is electrically connected to a gate electrode of the first field-effect transistor Q6, the gate electrode of the first field-effect transistor Q6 is electrically connected to a source electrode of the first field-effect transistor Q6, a drain electrode of the first field-effect transistor Q6 is electrically connected to the output terminal VRECT, the source electrode of the first field-effect transistor Q6 is electrically connected to the first terminal of the fifth capacitor C5, and the second terminal of the fifth capacitor C5 is electrically connected to the first midpoint AC1 or the second midpoint AC2. As such, the first field-effect transistor Q6 may be considered as a diode, the drain electrode of the first field-effect transistor Q6 may be considered as an anode of the diode, and the source electrode of the first field-effect transistor Q6 may be considered as a cathode of the diode.

A substrate of the second field-effect transistor Q7 is electrically connected to a gate electrode of the second field-effect transistor Q7, the gate electrode of the second field-effect transistor Q7 is electrically connected to a source electrode of the second field-effect transistor Q7, a drain electrode of the second field-effect transistor Q7 is electrically connected to the source electrode of the first field-effect transistor Q6, the source electrode of the second field-effect transistor Q7 is electrically connected to the first terminal of the sixth capacitor C6, the second terminal of the sixth capacitor C6 is grounded, and the source electrode of the second field-effect transistor Q7 is further electrically connected to the control terminal of the second switch transistor Q2 or the control terminal of the fourth switch transistor Q4. As such, the second field-effect transistor Q7 may be considered as a diode, the drain electrode of the second field-effect transistor Q7 may be considered as an anode of the diode, and the source electrode of the second field-effect transistor Q7 may be considered as a cathode of the diode.

The first diode VD1 or the first field-effect transistor Q6 is configured to control, within the first half cycle of the alternating current signal, the first unidirectional conducting branch to be in an ON state, and an ON direction of the first unidirectional conducting branch is from the first terminal f1 of the first unidirectional conducting branch to the second terminal f2 of the first unidirectional conducting branch.

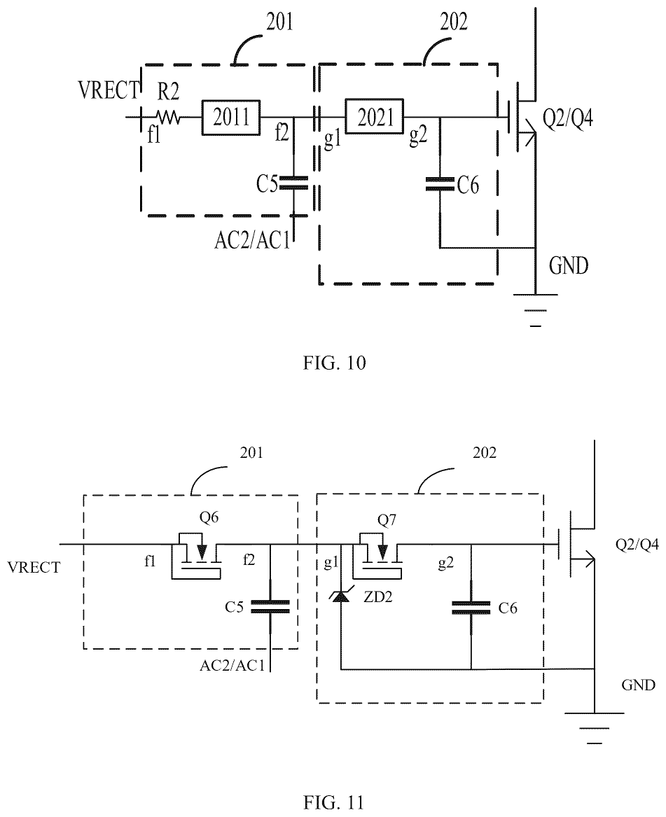

In some embodiments, as illustrated in FIG. 10, based on FIG. 6A, the first unidirectional conducting branch further includes a second resistor R2. A first terminal of the second resistor R2 is electrically connected to the output terminal VRECT of the wireless charging receiver circuit 10, and a second terminal of the second resistor R2 is electrically connected to the first unidirectional conducting device 201.

Specifically, in a case that the first unidirectional conducting device 2011 is the first diode VD1, the second terminal of the second resistor is electrically connected to the positive electrode of the first diode VD1. In a case that the first unidirectional conducting device is the first field-effect transistor Q6 which is an NMOS transistor, the second terminal of the second resistor is electrically connected to the source electrode of the first field-effect transistor Q6. In a case that the first unidirectional conducting device is the first field-effect transistor Q6 which is a PMOS transistor, the second terminal of the second resistor is electrically connected to the drain electrode of the first field-effect transistor Q6.

In some embodiments, the second energy storage circuit 202 further includes a second Zener diode. A positive electrode of the second Zener diode is grounded, and a negative electrode of the second Zener diode is electrically connected to the first terminal of the second unidirectional conducting device.

In a case that the second unidirectional conducting device 2021 on the second unidirectional conducting branch is a second diode VD2, the negative electrode of the second Zener diode is electrically connected to a positive electrode of the second diode VD2. In a case that the second unidirectional conducting device 2021 is a second field-effect transistor Q7 which is an NMOS transistor, the negative electrode of the second Zener diode is electrically connected to a source electrode of the second field-effect transistor Q7. In a case that the second unidirectional conducting device 2021 is a second field-effect transistor Q7 which is a PMOS transistor, the negative electrode of the second Zener diode is electrically connected to a drain electrode of the second field-effect transistor Q7.

Hereinafter, a structure of the second energy storage circuit 202 is illustrated by an example where a second Zener diode ZD2 is added in the half-bridge startup circuit as illustrated in FIG. 9.

FIG. 11 is a schematic structural diagram of a half-bridge startup circuit with a second Zener diode ZD2 added. As illustrated in FIG. 11, the second energy storage circuit 202 includes a second field-effect transistor Q7 and a second Zener diode ZD2. A source electrode of the second field-effect diode Q7 is electrically connected to a negative electrode of the second Zener diode ZD2, and a positive electrode of the second Zener diode ZD2 is grounded.

The second Zener diode ZD2 is turned on in a case that the voltage V_{g1} at the first terminal g1 of the second unidirectional conducting branch is greater than a first threshold, and is configured to clamp the voltage V_{g1} at the first terminal g1 of the second unidirectional conducting branch to be less than or equal to the first threshold.

The first threshold may be configured according to actual needs. For example, the first threshold is 5.5 V. Where V_{g1} is greater than the first threshold, damages may be caused to a gate oxide layer of the target switch transistor. Therefore, the V_{g1} needs to be clamped based on the predefined first threshold to prevent damaging the gate oxide layer of the target switch transistor, such that the rectifier circuit 101 stably operates in the half bridge mode.

The half-bridge startup circuit 20 as illustrated in FIG. 6A, FIG. 8, FIG. 9, and FIG. 10 according to the embodiments of the present disclosure, as compared with the half-bridge startup circuit as illustrated in FIG. 4 according to the related art, has a simple structure, uses fewer devices, and thus saves the manufacture cost.

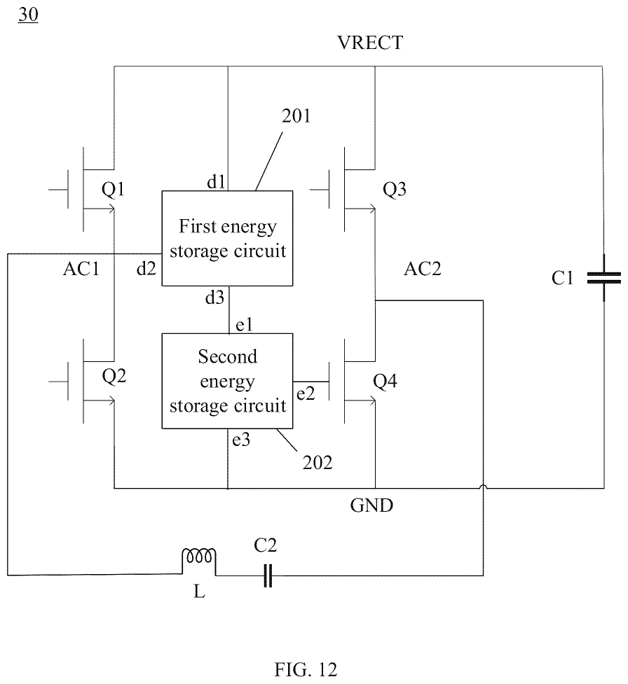

Some embodiments of the present disclosure further provide a wireless charging receiver. As illustrated in FIG. 12, the wireless charging receiver includes a receiver coil L, a second capacitor C2, a rectifier circuit 101, and a half-bridge startup circuit 20. The rectifier circuit 101 includes a first switch transistor Q1, a second switch transistor Q2, a third switch transistor Q3, a fourth switch transistor Q4, and a first capacitor C1. The half-bridge startup circuit 20 includes a first energy storage circuit 201 and a second energy storage circuit 202. FIG. 12 uses the case where the target switch transistor to be turned on in the half-bridge startup circuit is the fourth switch transistor Q4 as an example.

A second terminal of the first switch transistor Q1 is electrically connected to a first terminal of the second switch transistor Q2, a second terminal of the third switch transistor Q3 is electrically connected to a first terminal of the fourth switch transistor Q4, a first terminal of the first switch transistor Q1 and a first terminal of the third switch transistor Q3 are both electrically connected to the output terminal VRECT of the wireless charging circuit 10, a second terminal of the second switch transistor Q2 and a second terminal of the fourth switch transistor Q4 are both grounded, and the first terminal of the third switch transistor Q3 is further grounded via the first capacitor C1. A first midpoint AC1 is electrically connected to a first terminal of the receiver coil L, a second terminal of the receiver coil Lis electrically connected to a first terminal of the second capacitor C2, and a second terminal of the second capacitor C2 is electrically connected to a second midpoint AC2; wherein a point between the first switch transistor Q1 and the second switch transistor Q2 is defined as the first midpoint AC1, and a point between the third switch transistor Q3 and the fourth switch transistor Q4 is defined as the second midpoint AC2.

A first terminal d1 of the first energy storage circuit 201 is electrically connected to the output terminal VRECT of the wireless charging receiver circuit 10, a second terminal d2 of the first energy storage circuit 201 is electrically connected to the first midpoint AC1, and a third terminal d3 of the first energy storage circuit 201 is electrically connected to a first terminal e1 of the second energy storage circuit 202, a second terminal e2 of the second energy storage circuit 202 is electrically connected to a control terminal of the fourth switch transistor Q4, and a third terminal e3 of the second energy storage circuit 202 is grounded.

The receiver coil L is magnetically coupled to a transmitter coil in the wireless charging transmitter and electrically connected to the rectifier circuit 101, and is configured to receive an alternating current signal from the transmitter coil and transmit the alternating current signal to the rectifier circuit 101; and the rectifier circuit 101 is configured to convert the alternating current signal to a direct current charging signal for output.

Some embodiments of the present disclosure further provide a wireless charging system. The wireless charging system includes a wireless charging transmitter and a wireless charging receiver. The wireless charging receiver includes a wireless charging receiver circuit 10 and a half-bridge startup circuit 20. The half-bridge startup circuit 20 may employ the structure as described in any of the embodiments illustrated in FIG. 5, FIG. 6A, and FIG. 8 to FIG. 11. For the specific implementation, reference may be made to the above description. In addition, the implementation principle and the technical effects are similar, which are not described herein any further for brevity.

The features disclosed in the several circuit embodiments of the present disclosure may be freely combined to obtain new circuit embodiments, as long as there are no conflicts.

In summary, the above embodiments are used only for illustrating the present disclosure, but are not intended to limit the protection scope of the present disclosure. Various modifications and replacements readily derived by those skilled in the art within technical disclosure of the present disclosure shall fall within the protection scope of the present disclosure. Therefore, the protection scope of the present disclosure is subject to the appended claims.

What is claimed is:

1. A half-bridge startup circuit, electrically connected to a wireless charging receiver circuit, wherein
the wireless charging receiver circuit comprises a rectifier circuit and a resonant circuit;
the rectifier circuit comprises: a first switch transistor, a second switch transistor, a third switch transistor, a fourth switch transistor, and a first capacitor;
a second terminal of the first switch transistor is electrically connected to a first terminal of the second switch transistor, a second terminal of the third switch transistor is electrically connected to a first terminal of the fourth switch transistor, a first terminal of the first switch transistor and a first terminal of the third switch transistor are both electrically connected to an output terminal of the wireless charging receiver circuit, and a second terminal of the second switch transistor and a second terminal of the fourth switch transistor are both grounded; the first terminal of the third switch transistor is further grounded via the first capacitor; wherein a point between the first switch transistor and the second switch transistor is defined as a first midpoint, and a point between the third switch transistor and the fourth switch transistor is defined as a second midpoint;
the resonant circuit is configured to convert a signal transmitted from a wireless charging transmitter to an alternating current signal, and output the alternating current signal, via the first midpoint and the second midpoint, to the rectifier circuit; and the rectifier circuit is configured to convert the alternating current signal to a direct current charging signal for output; and
the half-bridge startup circuit comprises: a first energy storage circuit and a second energy storage circuit; wherein
a first terminal of the first energy storage circuit is electrically connected to the output terminal of the wireless charging receiver circuit, a second terminal of the first energy storage circuit is electrically connected to a target midpoint, a third terminal of the first energy storage circuit is electrically connected to a first terminal of the second energy storage circuit, a second terminal of the second energy storage circuit is electrically connected to a control terminal of a target switch transistor, and a third terminal of the second energy storage circuit is grounded; wherein the target midpoint is the second midpoint in a case that the target switch transistor is the second switch transistor, or the target midpoint is the first midpoint in a case that the target switch transistor is the fourth switch transistor;
within a first half cycle of the alternating current signal, the first energy storage circuit is charged based on a voltage at the output terminal and a voltage at the target midpoint, such that a first voltage difference between the second terminal and the third terminal of the first energy storage circuit increases;
within a second half cycle of the alternating current signal, the first energy storage circuit is discharged to transmit electric energy to the second energy storage circuit, such that a second voltage difference between the second terminal and the third terminal of the second energy storage circuit increases; and
in a case that the second voltage difference is greater than a threshold voltage of the target switch transistor, the target switch transistor is turned on, another switch transistor on a same bridge arm as the target switch transistor is turned off, and two switch transistors on a bridge arm not including the target switch transistor in the rectifier circuit are alternately turned on to convert the alternating current signal output by the resonant circuit to the direct current charging signal; wherein in a case that the target switch transistor is turned on, the second voltage difference is greater than the voltage at the output terminal; wherein the first switch transistor and the second switch transistor are arranged on a bridge arm, and the third switch transistor and the fourth switch transistor are arranged on another bridge arm.

2. The half-bridge startup circuit according to claim 1, wherein the first energy storage circuit comprises: a first unidirectional conducting branch and a first energy storage branch; wherein the first energy storage branch comprises one fifth capacitor or a plurality of fifth capacitors that are connected in series; and an ON direction of the first unidirectional conducting branch is from a first terminal of the first unidirectional conducting branch to a second terminal of the first unidirectional conducting branch; wherein
the first terminal of the first unidirectional conducting branch, as the first terminal of the first energy storage circuit, is electrically connected to the output terminal of the wireless charging receiver circuit;
in a case that the first energy storage branch comprises one fifth capacitor, the second terminal of the first unidirectional conducting branch, as the third terminal of the first energy storage circuit, is electrically connected to a first terminal of the fifth capacitor, and a second terminal of the fifth capacitor is electrically connected to the target midpoint; or in a case that the first energy storage branch comprises a plurality of fifth capacitors that are connected in series, the second terminal of the first unidirectional conducting branch is electrically connected to a first terminal of a 1^{st} fifth capacitor in the plurality of fifth capacitors that are connected in series, a second terminal of a last fifth capacitor in the plurality of fifth capacitors that are connected in series is electrically connected to the target midpoint, and a second terminal of an i^{th} fifth capacitor in the plurality of fifth capacitors that are connected in series is electrically connected to a first terminal of an (i+1)^{th} fifth capacitor in the plurality of fifth capacitors that are connected in series, wherein i is greater than 0 and is less than a number of the fifth capacitors; and
within the first half cycle of the alternating current signal, the first unidirectional conducting branch is in an ON state, the fifth capacitor or the plurality of fifth capacitors that are connected in series on the first energy storage branch are charged based on the voltage at the output terminal of the wireless charging receiver circuit and the voltage at the target midpoint, such that a voltage difference between two terminals of the first energy storage branch increases.

3. The half-bridge startup circuit according to claim 2, wherein the first unidirectional conducting branch comprises a first unidirectional conducting device, the first unidirectional conducting device being a first diode, an N-type metal-oxide-semiconductor (NMOS) transistor, or a P-type metal-oxide-semiconductor (PMOS) transistor; wherein
in a case that the first unidirectional conducting device is the first diode, a positive electrode of the first diode, as the first terminal of the first unidirectional conducting branch, is electrically connected to the output terminal of the wireless charging receiver circuit, and a negative electrode of the first diode, as the second terminal of the first unidirectional conducting branch, is electrically connected to the first terminal of the fifth capacitor or is electrically connected to the first terminal of the 1^{st} fifth capacitor in the plurality of fifth capacitors that are connected in series; or in a case that the first unidirectional conducting device is the NMOS transistor, a substrate of the NMOS transistor is electrically connected to a gate electrode of the NMOS transistor, the gate electrode of the NMOS is electrically connected to a source electrode of the NMOS transistor, the source electrode of the NMOS transistor, as the first terminal of the first unidirectional conducting branch, is electrically connected to the output terminal of the wireless charging receiver circuit, and a drain electrode of the NMOS transistor, as the second terminal of the first unidirectional conducting branch, is electrically connected to the first terminal of the fifth capacitor or is electrically connected to the first terminal of the 1^{st} fifth capacitor in the plurality of fifth capacitors that are connected in series; or in a case that the first unidirectional conducting device is the PMOS transistor, a substrate of the PMOS transistor is electrically connected to a gate electrode of the PMOS transistor, the gate electrode of the PMOS transistor is electrically connected to a source electrode of the PMOS transistor, a drain electrode of the PMOS transistor, as the first terminal of the first unidirectional conducting branch, is electrically connected to the output terminal of the wireless charging receiver circuit, and a source electrode of the PMOS transistor, as the second terminal of the first unidirectional conducting branch, is electrically connected to the first terminal of the fifth capacitor or is electrically connected to the first terminal of the 1^{st} fifth capacitor in the plurality of fifth capacitors that are connected in series; and
the first unidirectional conducting device is turned on within the first half cycle of the alternating current signal, such that the first unidirectional conducting branch is in the ON state.

4. The half-bridge startup circuit according to claim 3, wherein the first unidirectional conducting branch further comprises a second resistor, a first terminal of the second resistor is electrically connected to the output terminal of the wireless charging receiver circuit; wherein
in a case that the first unidirectional conducting device is the first diode, a second terminal of the second resistor is electrically connected to the positive electrode of the first diode; or in a case that the first unidirectional conducting device is the NMOS transistor, a second terminal of the second resistor is electrically connected to the source electrode of the NMOS transistor; or in a case that the first unidirectional conducting device is the PMOS transistor, a second terminal of the second resistor is electrically connected to the drain electrode of the PMOS transistor; and
the second resistor is configured to limit a current on the first unidirectional conducting branch.

5. The half-bridge startup circuit according to claim 1, wherein the second energy storage circuit comprises: a second unidirectional conducting branch and a second energy storage branch; wherein the second energy storage branch comprises one sixth capacitor or a plurality of sixth capacitors that are connected in series; and an ON direction of the second unidirectional conducting branch is from a first terminal of the second unidirectional conducting branch to a second terminal of the second unidirectional conducting branch; wherein
a first terminal of the second unidirectional conducting branch, as the first terminal of the second energy storage circuit, is electrically connected to the third terminal of the first energy storage circuit, and a second terminal of the second unidirectional conducting branch, as the second terminal of the second energy storage circuit, is electrically connected to the control terminal of the target switch transistor;
in a case that the second energy storage branch comprises one sixth capacitor, the second terminal of the second unidirectional conducting branch is electrically connected to a first terminal of the sixth capacitor, and a second terminal of the sixth capacitor is grounded; or in a case that the second energy storage branch comprises the plurality of sixth capacitors that are connected in series, the second terminal of the second unidirectional conducting branch is electrically connected to a first terminal of a 1^{st} sixth capacitor in the plurality of sixth capacitors that are connected in series, a second terminal of a last sixth capacitor in the plurality of sixth capacitors that are connected in series is grounded, and a second terminal of a j^{th} sixth capacitor in the plurality of sixth capacitors that are connected in series is electrically connected to a first terminal of a (j+1)^{th} sixth capacitor in the plurality of sixth capacitors that are connected in series, wherein j is greater than 0 and is less than a number of the sixth capacitors; and
within the second half cycle of the alternating current signal, the second unidirectional conducting branch is in an ON state, the 1^{st} sixth capacitor or the plurality of sixth capacitors that are connected in series on the second energy storage branch are charged based on a voltage at the third terminal of the first energy storage circuit, such that a voltage difference between two terminals of the second energy storage branch increases.

6. The half-bridge startup circuit according to claim 5, wherein the second unidirectional conducting branch comprises a second unidirectional conducting device, the second unidirectional conducting device being a second diode, an N-type metal-oxide-semiconductor (NMOS) transistor, or a P-type metal-oxide-semiconductor (PMOS) transistor; wherein
in a case that the second unidirectional conducting device is the second diode, a positive electrode of the second diode, as the first terminal of the second unidirectional conducting branch, is electrically connected to the third terminal of the first energy storage circuit, and a negative electrode of the second diode, as the second terminal of the second unidirectional conducting branch, is electrically connected to the control terminal of the target switch transistor; or
in a case that the second unidirectional conducting device is the NMOS transistor, a substrate of the NMOS transistor is electrically connected to a gate electrode of the NMOS transistor, the gate electrode of the NMOS transistor is electrically connected to a source electrode of the NMOS transistor, the source electrode of the NMOS transistor, as the first terminal of the second unidirectional conducting branch, is electrically connected to the third terminal of the first energy storage circuit, and a drain electrode of the NMOS transistor, as the second terminal of the second unidirectional conducting branch, is electrically connected to the control terminal of the target switch transistor; or
in a case that the second unidirectional conducting device is the PMOS transistor, a substrate of the PMOS transistor is electrically connected to a gate electrode of the PMOS transistor, the gate electrode of the PMOS transistor is electrically connected to a source electrode of the PMOS transistor, a drain electrode of the PMOS transistor, as the first terminal of the second unidirectional conducting branch, is electrically connected to the third terminal of the first energy storage circuit, and a source electrode of the PMOS transistor, as the second terminal of the second unidirectional conducting branch, is electrically connected to the control terminal of the target switch transistor.

7. The half-bridge startup circuit according to claim 5, wherein the second energy storage circuit further comprises a second Zener diode; wherein
a negative electrode of the second Zener diode is electrically connected to the first terminal of the second unidirectional conducting branch, and a positive electrode of the second Zener diode is grounded; and
the second Zener diode is turned on in a case that a voltage at the first terminal of the second unidirectional conducting branch is greater than a first threshold, and is configured to clamp the voltage at the first terminal of the second energy storage circuit to be less than or equal to the first threshold.

8. The half-bridge startup circuit according to claim 1, wherein the target switch transistor is the fourth switch transistor; wherein
within the first half cycle of the alternating current signal, the second switch transistor and the third switch transistor are turned on, and the fourth switch transistor and the second switch transistor are turned off; and
within the second half cycle of the alternating current signal, the second switch transistor and the third switch transistor are turned off, and the fourth switch transistor and the second switch transistor are turned on.

9. The half-bridge startup circuit according to claim 1, wherein the target switch transistor is the second switch transistor; wherein
within the first half cycle of the alternating current signal, the second switch transistor and the third switch transistor are turned off, and the fourth switch transistor and the second switch transistor are turned on; and
within the second half cycle of the alternating current signal, the second switch transistor and the third switch transistor are turned on, and the fourth switch transistor and the second switch transistor are turned off.

10. A wireless charging receiver, comprising: a half-bridge startup circuit and a wireless charging receiver circuit, wherein
the wireless charging receiver circuit comprises a rectifier circuit and a resonant circuit;
the rectifier circuit comprises: a first switch transistor, a second switch transistor, a third switch transistor, a fourth switch transistor, and a first capacitor;
a second terminal of the first switch transistor is electrically connected to a first terminal of the second switch transistor, a second terminal of the third switch transistor is electrically connected to a first terminal of the fourth switch transistor, a first terminal of the first switch transistor and a first terminal of the third switch transistor are both electrically connected to an output terminal of the wireless charging receiver circuit, and a second terminal of the second switch transistor and a second terminal of the fourth switch transistor are both grounded; the first terminal of the third switch transistor is further grounded via the first capacitor; wherein a point between the first switch transistor and the second switch transistor is defined as a first midpoint, and a point between the third switch transistor and the fourth switch transistor is defined as a second midpoint;
the resonant circuit is configured to convert a signal transmitted from a wireless charging transmitter to an alternating current signal, and output the alternating current signal, via the first midpoint and the second midpoint, to the rectifier circuit; and the rectifier circuit is configured to convert the alternating current signal to a direct current charging signal for output; and
the half-bridge startup circuit comprises: a first energy storage circuit and a second energy storage circuit; wherein
a first terminal of the first energy storage circuit is electrically connected to the output terminal of the wireless charging receiver circuit, a second terminal of the first energy storage circuit is electrically connected to a target midpoint, a third terminal of the first energy storage circuit is electrically connected to a first terminal of the second energy storage circuit, a second terminal of the second energy storage circuit is electrically connected to a control terminal of a target switch transistor, and a third terminal of the second energy storage circuit is grounded; wherein the target midpoint is the second midpoint in a case that the target switch transistor is the second switch transistor, or the target midpoint is the first midpoint in a case that the target switch transistor is the fourth switch transistor;
within a first half cycle of the alternating current signal, the first energy storage circuit is charged based on a voltage at the output terminal and a voltage at the target midpoint, such that a first voltage difference between the second terminal and the third terminal of the first energy storage circuit increases;
within a second half cycle of the alternating current signal, the first energy storage circuit is discharged to transmit electric energy to the second energy storage circuit, such that a second voltage difference between the second terminal and the third terminal of the second energy storage circuit increases; and
in a case that the second voltage difference is greater than a threshold voltage of the target switch transistor, the target switch transistor is turned on, another switch transistor on a same bridge arm as the target switch transistor is turned off, and two switch transistors on a bridge arm not including the target switch transistor in the rectifier circuit are alternately turned on to convert the alternating current signal output by the resonant circuit to the direct current charging signal; wherein in a case that the target switch transistor is turned on, the second voltage difference is greater than the voltage at the output terminal; wherein the first switch transistor and the second switch transistor are arranged on a bridge arm, and the third switch transistor and the fourth switch transistor are arranged on another bridge arm.

11. The wireless charging receiver according to claim 10, wherein the first energy storage circuit comprises: a first unidirectional conducting branch and a first energy storage branch; wherein the first energy storage branch comprises one fifth capacitor or a plurality of fifth capacitors that are connected in series; and an ON direction of the first unidirectional conducting branch is from a first terminal of the first unidirectional conducting branch to a second terminal of the first unidirectional conducting branch; wherein
the first terminal of the first unidirectional conducting branch, as the first terminal of the first energy storage circuit, is electrically connected to the output terminal of the wireless charging receiver circuit;
in a case that the first energy storage branch comprises one fifth capacitor, the second terminal of the first unidirectional conducting branch, as the third terminal of the first energy storage circuit, is electrically connected to a first terminal of the fifth capacitor, and a second terminal of the fifth capacitor is electrically connected to the target midpoint; or in a case that the first energy storage branch comprises a plurality of fifth capacitors that are connected in series, the second terminal of the first unidirectional conducting branch is electrically connected to a first terminal of a 1^{st} fifth capacitor in the plurality of fifth capacitors that are connected in series, a second terminal of a last fifth capacitor in the plurality of fifth capacitors that are connected in series is electrically connected to the target midpoint, and a second terminal of an i^{th} fifth capacitor in the plurality of fifth capacitors that are connected in series is electrically connected to a first terminal of an (i+1)^{th} fifth capacitor in the plurality of fifth capacitors that are connected in series, wherein i is greater than 0 and is less than a number of the fifth capacitors; and
within the first half cycle of the alternating current signal, the first unidirectional conducting branch is in an ON state, the fifth capacitor or the plurality of fifth capacitors that are connected in series on the first energy storage branch are charged based on the voltage at the output terminal of the wireless charging receiver circuit and the voltage at the target midpoint, such that a voltage difference between two terminals of the first energy storage branch increases.

12. The wireless charging receiver according to claim 11, wherein the first unidirectional conducting branch comprises a first unidirectional conducting device, the first unidirectional conducting device being a first diode, an N-type metal-oxide-semiconductor (NMOS) transistor, or a P-type metal-oxide-semiconductor (PMOS) transistor; wherein
in a case that the first unidirectional conducting device is the first diode, a positive electrode of the first diode, as the first terminal of the first unidirectional conducting branch, is electrically connected to the output terminal of the wireless charging receiver circuit, and a negative electrode of the first diode, as the second terminal of the first unidirectional conducting branch, is electrically connected to the first terminal of the fifth capacitor or is electrically connected to the first terminal of the 1^{st} fifth capacitor in the plurality of fifth capacitors that are connected in series; or in a case that the first unidirectional conducting device is the NMOS transistor, a substrate of the NMOS transistor is electrically connected to a gate electrode of the NMOS transistor, the gate electrode of the NMOS is electrically connected to a source electrode of the NMOS transistor, the source electrode of the NMOS transistor, as the first terminal of the first unidirectional conducting branch, is electrically connected to the output terminal of the wireless charging receiver circuit, and a drain electrode of the NMOS transistor, as the second terminal of the first unidirectional conducting branch, is electrically connected to the first terminal of the fifth capacitor or is electrically connected to the first terminal of the 1^{st} fifth capacitor in the plurality of fifth capacitors that are connected in series; or in a case that the first unidirectional conducting device is the PMOS transistor, a substrate of the PMOS transistor is electrically connected to a gate electrode of the PMOS transistor, the gate electrode of the PMOS transistor is electrically connected to a source electrode of the PMOS transistor, a drain electrode of the PMOS transistor, as the first terminal of the first unidirectional conducting branch, is electrically connected to the output terminal of the wireless charging receiver circuit, and a source electrode of the PMOS transistor, as the second terminal of the first unidirectional conducting branch, is electrically connected to the first terminal of the fifth capacitor or is electrically connected to the first terminal of the 1^{st} fifth capacitor in the plurality of fifth capacitors that are connected in series; and
the first unidirectional conducting device is turned on within the first half cycle of the alternating current signal, such that the first unidirectional conducting branch is in the ON state.

13. The wireless charging receiver according to claim 12, wherein the first unidirectional conducting branch further comprises a second resistor, a first terminal of the second resistor is electrically connected to the output terminal of the wireless charging receiver circuit; wherein
in a case that the first unidirectional conducting device is the first diode, a second terminal of the second resistor is electrically connected to the positive electrode of the first diode; or in a case that the first unidirectional conducting device is the NMOS transistor, a second terminal of the second resistor is electrically connected to the source electrode of the NMOS transistor; or in a case that the first unidirectional conducting device is the PMOS transistor, a second terminal of the second resistor is electrically connected to the drain electrode of the PMOS transistor; and
the second resistor is configured to limit a current on the first unidirectional conducting branch.

14. The wireless charging receiver according to claim 10, wherein the second energy storage circuit comprises: a second unidirectional conducting branch and a second energy storage branch; wherein the second energy storage branch comprises one sixth capacitor or a plurality of sixth capacitors that are connected in series; and an ON direction of the second unidirectional conducting branch is from a first terminal of the second unidirectional conducting branch to a second terminal of the second unidirectional conducting branch; wherein
a first terminal of the second unidirectional conducting branch, as the first terminal of the second energy storage circuit, is electrically connected to the third terminal of the first energy storage circuit, and a second terminal of the second unidirectional conducting branch, as the second terminal of the second energy storage circuit, is electrically connected to the control terminal of the target switch transistor;
in a case that the second energy storage branch comprises one sixth capacitor, the second terminal of the second unidirectional conducting branch is electrically connected to a first terminal of the sixth capacitor, and a second terminal of the sixth capacitor is grounded; or in a case that the second energy storage branch comprises the plurality of sixth capacitors that are connected in series, the second terminal of the second unidirectional conducting branch is electrically connected to a first terminal of a 1^{st} sixth capacitor in the plurality of sixth capacitors that are connected in series, a second terminal of a last sixth capacitor in the plurality of sixth capacitors that are connected in series is grounded, and a second terminal of a j^{th} sixth capacitor in the plurality of sixth capacitors that are connected in series is electrically connected to a first terminal of a (j+1)^{th} sixth capacitor in the plurality of sixth capacitors that are connected in series, wherein j is greater than 0 and is less than a number of the sixth capacitors; and
within the second half cycle of the alternating current signal, the second unidirectional conducting branch is in an ON state, the 1^{st} sixth capacitor or the plurality of sixth capacitors that are connected in series on the second energy storage branch are charged based on a voltage at the third terminal of the first energy storage circuit, such that a voltage difference between two terminals of the second energy storage branch increases.

15. The wireless charging receiver according to claim 14, wherein the second unidirectional conducting branch comprises a second unidirectional conducting device, the second unidirectional conducting device being a second diode, an N-type metal-oxide-semiconductor (NMOS) transistor, or a P-type metal-oxide-semiconductor (PMOS) transistor; wherein
in a case that the second unidirectional conducting device is the second diode, a positive electrode of the second diode, as the first terminal of the second unidirectional conducting branch, is electrically connected to the third terminal of the first energy storage circuit, and a negative electrode of the second diode, as the second terminal of the second unidirectional conducting branch, is electrically connected to the control terminal of the target switch transistor; or
in a case that the second unidirectional conducting device is the NMOS transistor, a substrate of the NMOS transistor is electrically connected to a gate electrode of the NMOS transistor, the gate electrode of the NMOS transistor is electrically connected to a source electrode of the NMOS transistor, the source electrode of the NMOS transistor, as the first terminal of the second unidirectional conducting branch, is electrically connected to the third terminal of the first energy storage circuit, and a drain electrode of the NMOS transistor, as the second terminal of the second unidirectional conducting branch, is electrically connected to the control terminal of the target switch transistor; or
in a case that the second unidirectional conducting device is the PMOS transistor, a substrate of the PMOS transistor is electrically connected to a gate electrode of the PMOS transistor, the gate electrode of the PMOS transistor is electrically connected to a source electrode of the PMOS transistor, a drain electrode of the PMOS transistor, as the first terminal of the second unidirectional conducting branch, is electrically connected to the third terminal of the first energy storage circuit, and a source electrode of the PMOS transistor, as the second terminal of the second unidirectional conducting branch, is electrically connected to the control terminal of the target switch transistor.

16. The wireless charging receiver according to claim 14, wherein the second energy storage circuit further comprises a second Zener diode; wherein
a negative electrode of the second Zener diode is electrically connected to the first terminal of the second unidirectional conducting branch, and a positive electrode of the second Zener diode is grounded; and
the second Zener diode is turned on in a case that a voltage at the first terminal of the second unidirectional conducting branch is greater than a first threshold, and is configured to clamp the voltage at the first terminal of the second energy storage circuit to be less than or equal to the first threshold.

17. The wireless charging receiver according to claim 10, wherein the target switch transistor is the fourth switch transistor; wherein
within the first half cycle of the alternating current signal, the second switch transistor and the third switch transistor are turned on, and the fourth switch transistor and the second switch transistor are turned off; and
within the second half cycle of the alternating current signal, the second switch transistor and the third switch transistor are turned off, and the fourth switch transistor and the second switch transistor are turned on.

18. The wireless charging receiver according to claim 10, wherein the target switch transistor is the second switch transistor; wherein
within the first half cycle of the alternating current signal, the second switch transistor and the third switch transistor are turned off, and the fourth switch transistor and the second switch transistor are turned on; and
within the second half cycle of the alternating current signal, the second switch transistor and the third switch transistor are turned on, and the fourth switch transistor and the second switch transistor are turned off.

19. A chip, comprising: the half-bridge startup circuit as defined in claim 1.
